(19) United States
(12) Patent Application Publication
(10) Pub. No.: US 2005/0158212 A1
(43) Pub. Date: Jul. 21, 2005

(54) Automated laboratory system and analytical module

(76) Inventor: Michael Yavilevich, Kiriat Bialik (IL)

Correspondence Address: Michael Yavilevich, 5 Haim St. Ap. 4, Kiriat Bialik, 27076, IL

(21) Appl. No.: 10/965,485

(22) Filed: Oct. 15, 2004

Related U.S. Application Data
(60) Provisional application No. 60/537,093, filed on Jan. 15, 2004.

(51) Int. Cl. B01L 3/00

(52) U.S. Cl. 422/100

(57) ABSTRACT

Laboratory Automated System and method for specimen processing, comprising several Clinical and Biological Analytical Modules is provided. The Module consists of coupling centrifuge, analyzers and robot. System produces rapid phase separation, cap removing and testing in one sequential, unbroken process. Several multi-item carriers for tubes and microplates loading provided.

This application claims the benefit of provisional applications:
app. Ser. No. 60/511,852 Filing date: Oct. 14, 2003 Applicant: Michael Yavilevich
app. Ser. No. 60/537,093 Filing date: Jan. 15, 2004 Applicant: Michael Yavilevich

### BACKGROUND OF THE INVENTION

There have been developed various Laboratory Automated Systems and Automated Centrifuging Systems. Unfortunately the constructions of the Total Laboratory Automated Systems (TLA) and Automated Centrifugation assemblies are very complicated and not suitable for implementation in small and medium clinical laboratories. TLA Technology requires arranging tubes in a line on a transport track before testing. An example of the conveyer system manufacturing by Lab-InterLink, Inc. shows in U.S. Pat. No. 5,614,415. This system uses individual carrier for every specimen tube, movable on the conveyer.

Since new powerful Analyzers were appearing in Laboratory, tube sorting, sample balancing and separation, robotics load-unload and recapping were arranged around this machines. Some attempts were made to bring testing process nearer physician office. The and for small and medium labs is toward modular automation of analytical processes. An example of module system is described in U.S. Pat. Nos. 6,060,022 and 6,776,961 assigned to Beckman Coulter, Inc. This system uses a number of robots and different tube carriers in centrifuge and analyzer. These systems use many loading-unloading and aliquoting steps and complicated.

The other example of module system is described in U.S. Pat. No. 6,323,035 assigned to Glaxo Wellcome, Inc. and U.S. Pat. No. 6,691,748 assigned to Precision System Science Co. These assemblies consisting devices and methods for manipulating and handling multi-well plates, but do not provides the step of tube handling and specimen sampling from tubes to microplates.

Numerous instruments and devices have been developed to increase the efficiency of testing procedures by reducing turnaround time. Original sample preparation systems include many loading-unloading steps. The key goal for automation in diagnostics is to minimize all steps in the lab processes like sorting tubes, recapping, centrifugation, loading tubes in analyzers racks, microplate sampling, testing and storage.

### BRIEF SUMMARY OF THE INVENTION

The present invention refers to structure of Laboratory Automated System and to modular automation of pre-analytical and analytical processes of Clinical and Bio Lab Testing Systems. More particularly the present invention relates to compact Analytical Station for loading-unloading tubes, removal-replacement a caps, rapid centrifugation, sampling microplates and testing.

It is an object of the present invention to provide Universal Laboratory Automated System (ULAS) in general and Fast Automated Analytical Stations (FAAS) in particular. ULAS consist of a grade structure and comprise a number of local Clinical and Biological Automated Analytical Stations.

According to aspect of the present invention said Clinical Automated Analytical Station contains several Clinical Analytical Modules. Each module may contain coupling centrifuge, robot and at least one analyzer. Centrifuge and analyzer may comprise common parts and devices like refrigerator, motors. Robot arranged near analyzer sampling port and centrifuge loading-unloading port

According to yet another aspect of the present invention said Biological Automated Analytical Station contains several Biological Analytical Modules. Said module contains coupling sorting deck, robot, centrifuge, dispensary, analyzer and storage units. Centrifuge, analyzer and robot may comprise common parts and devices like refrigerator, motors. Dispensing unit locates near centrifuge loading-unloading port.

According to another aspect of the present invention there is provided batch methods for loading and unloading tubes, rapid centrifugation, cap removing and sampling for analysis. Tubes number and arrangement in a batch conform to number and arrangement tubes in a centrifuge holding means and suitable for connection to analyzer and robotic assembly.

According to yet another aspect of the present invention there is provided batch loading-unloading method using universal multi-item transporting means. All transporting carriers contain the same protrusions—wings and/or apertures—slots, permitting arranging in the same Robot simple plate handling gripper. This embodiment allows employing standard robot equipped with plate handling, fork shape grippers.

All multi-item members effectively connecting with a centrifuge, dispensary, analytical instrument and robot and including:
a) Multi-item carrier (MIC) intends for tube loading and unloading inside centrifuge, handler and analyzer.
b) Universal adapter intends for tube loading and unloading inside centrifuge, handler and analyzer.
c) Multi-item plate (MIP) intends for tube loading inside centrifuge and for cap moving away after centrifugation. Said plate provides with compartments for caps placing.
d) Multi-item cap covering (MCC) intends for tube loading inside centrifuge and for cap moving away after centrifugation. Said cap covering provides with springy compartments for engagement with the cylindrical walls of the caps so as frictionally resist movement of the caps within the cap covering, but easy put on the caps.
e) Multi-Cap (MC) intends for tubes recapping and removing from centrifuge to refrigerator storage. Said multi-cap includes springy compartments for engagement with the cylindrical walls of the tubes so as frictionally resist movement of the tube within the multi-cap, but easy put and removed from the tubes.
f) Multi well plate—microplate for biological test.
g) Microplate adapter for loading microplates inside centrifuge.

According to yet another aspect of the present invention there is provided a robotic assembly for delivering samples to module in general and to centrifuge and analyzer in particular. All transporting means contain same parts to fit with simply robotic gripper. This embodiment allows employing standard plate handling robot equipped with fork shape gripper. Said robot intends for placing tubes inside MIC or universal adapter and delivering said means with tubes to centrifuge. Robot moves said means with tubes after specimen separation and cap removing to analyzer. Robot moves away MIP or MCC with caps from centrifuge. Robot transfers tubes closed by multi-caps to storage, after specimen testing. Robot takes multi-cap by wings or slots, put it on the tubes, connect multi-cap with tubes and transfer all batch to refrigerator or storage area.

According to yet another aspect of the present invention there is provided Fast Spin Centrifuge. Said centrifuge use variably inclination method for rapid separation. Centrifuge casing and drum providing with at least one aperture in upper part of side walls. Apertures use for tube loading-unloading and for direct centrifuge sampling. Electro-mechanical hatches or sash doors close said apertures during rotor spin.

According to yet another aspect of the present invention there is provided batch cap removing method affected in a said fast centrifuge. The cap removing means is operas by virtue of the centrifugal force developed during the centrifugation run. Said method, realize by using several multi-item means:
a) Insert arranged inside universal adapter before tube loading;
b) Multi-item plate (MIP) or multi-item cap covering (MCC) intends for cap moving away after centrifugation.

According to yet another aspect of the present invention analyzer provided with specimen carousel for multi-item carriers or universal adapter placing. Said carousel comprises a number of identical receptacles for receiving multi-item carriers. Inner surface of the carouse fit an outside surface of the MIC and universal adapter to allow inserting said means into the Analyzer.

According to yet another aspect of the present invention there is provided stationary carriage or movable bidirectional carriage-shuttle. Carriage intends to MIC or universal adapter placing. Inner surface of the carriage fit an outside surface of the MIC and universal adapter to allow inserting said means into or near the analyzer. Movable bidirectional shuttle uses in conjunction with standard sample probe.

According to yet another aspect of the present invention there is provided multi-coordinate specimen probe or swing out specimen probe. Multi-coordinate probe uses in conjunction with stationary carriage. Swinging probe uses in conjunction with analyzer indexing specimen carousel or indexing centrifuge rotor.

According to yet another aspect of the present invention there is provided MIC handier, displacing between standard centrifuge and analyzer. Said handler comprise multi-coordinate specimen probe or swing out probe. Said handler may comprise carriage—shuttle or conveyer for MIC placing.

According to yet another aspect of the present invention there is provided direct—centrifuge sampling method, effected by using indexing centrifuge rotor and turn out indexing sample probe.

According to direct-centrifuge sampling method of the present invention, centrifuge provided with indexing centrifuge rotor and turn out indexing sample probe.

According to yet another aspect of the present invention there is provided dispensing unit equipped with a robot. Dispensing unit located near Centrifuge loading area and near Biological Analyzer. Dispensing unit intends for microplates sampling and adding reagent before testing.

According to yet another aspect of the present invention there is provided machine method for specimen identification, detection, measurement and high speed calculation. Sorting Deck provided with specimen measuring system and software integrated with Laboratory Information System.

This invention includes a methods and devices for rapid phase separation and cap removing in liquids. These methods now named Fast Spin were described in U.S. Pat. No. 6,234,948.

Universal Laboratory Automated System (ULAS) consists of grade structures and comprises several parts:
General Level:—several High Level Laboratory Systems,
High Level:—Main Laboratory,
Middle Level:—number of Clinical and Biologic Analytical Stations,
Ground Level:—Hospitals, blood taking stations and Physicians Offices.

General Information System (GIS) include a Main Information System (MIS) and a number of Local Information Systems (LIS). Every LIS cooperate local FAAS with its users. Clinical Automated Analytical Station may consist of coupling units:
sorting deck,
rapid centrifugation assembly equipped with swing-out rotor. Said centrifuge comprise electro-magnetically unit for displacing the common center of gravity of the holding means,
at least one robotic assembly,
at least one analyzer,
common information system, bar code system; and
storage area.

Biological Automated Analytical Station may consist of coupling units:
sorting Deck,
centrifugation assembly,
robotic assembly,
analyzer,
dispensing unit,
common information system, bar code system; and
storage area.

Sample preparation in the sorting deck includes the following steps:
detecting an inappropriate sample;
dimension the sample volume;
placing tubes inside MIC;
memorize bar codes and tube arrangement in the MIC;
further loading MIC with tubes into centrifuge buckets.

Sorting deck equipped by weight line. Balance takes a weight of every tube and sends it to computer, which calculates common weight of all samples and determinate virtual batch arrangement. Computer calculates common dimensions of all samples and determinate virtual batch arrangement. Robot picks certain tubes from racks or conveyer and places them inside MIC. Identification system memorizes bar codes, tube arrangement and sample volume of all batches. Preliminary sample volume dimension allow compiling batches with equal weight. This provision gives good centrifuge rotor balancing.

A method for routing a specimen through Clinical Automated Analytical Station, by using direct centrifuge sampling method of the present invention comprises main steps:
Physicians give orders to patients and to LIS.
Taking blood and bar code placing on a tube.
Sending tubes to local FAAS.
Receiving tubes in the FAAS sorting deck.
Sample volume dimension and making batch size calculation;
Memorizing bar codes, tube arrangement and sample volume of all batch.
Placing tubes in an appropriate multi-item carrier.
Placing the multi-item carriers with tubes inside centrifuge bucket.
Spinning the tubes with samples while they are inclined for more rapid phase separation.
Lowering the tubes adapter inside the bucket during spinning, for tubes pivoting into horizontal position.
Spinning the tubes while their longitudinal axes are aligned with the direction of the centrifugation force to allow reliable gel seal.
Displacing the tubes inside the holding means during spinning, for caps removing.
Stopping the centrifuge and opening the centrifuge hatches.
Unloading the cap removing means with caps from centrifuge.
Tube identification before specimen testing.
Sucking specimen from tubes loaded inside centrifuge.
Dropping specimen on analyzer processing ring.
Testing specimens in analyzer.
Placing multi-item cap on tubes.
Tubes removing from centrifuge.
Placing tubes to refrigerator storage.
Sending test result to physician office.

A method for routing a specimen through Biological Automated Analytical Station, by using direct Centrifuge sampling method of the present invention comprises main steps:
Physicians give orders to patients and to LIS.
Taking blood and bar code placing on a tube.
Sending tubes to local FAAS.
Receiving tubes in the FAAS sorting deck.
Sample volume dimension and making batch size calculation;
Memorizing bar codes, tube arrangement and sample volume of all batch.
Placing tubes in an appropriate multi-item carrier.
Placing the multi-item carrier s with tubes inside centrifuge bucket.
Spinning the tubes with samples while they are inclined for more rapid phase separation.
Lowering the tubes adapter inside the bucket during spinning, for tubes pivoting into horizontal position.
Spinning the tubes while their longitudinal axes are aligned with the direction of the centrifugation force to allow reliable gel seal.
Displacing the tubes inside the holding means during spinning, for caps removing.
Stopping the centrifuge and opening the centrifuge hatches.
Unloading the cap removing means with caps from centrifuge.
Tube identification before specimen sampling to microplates.
Placing empty microplates on movable bidirectional carriage arranged near centrifuge, for microplates sampling and reagent adding.
Sampling specimens from the tubes loaded within centrifuge to microplate wells by using swinging multi-coordinate sampling probe.
Adding reagents to microplates in dispensing unit.
Placing said microplates inside plate hotel.
Placing said microplates in Analyzer sampling inlet.
Conducting the test on the first set of specimens.
Removing multi-item carriers from centrifuge and microplates from analyzer by using robotic assembly.
Sending test result to physician office.

The clinical module may comprise compact analyzer formed integrally with Fast Spin centrifuge and a robot. The interior of the module may consist of common analyzer and centrifuge parts. The module provided with centrifuge loading port. Centrifuge loading port may arrange within the interior of the analyzer.

According to the present invention robot can be individual for each module or common for a number modules in the station. Standard six single degree of freedom joints robot provided with a simple plate handling gripper may placed near the module.

Robotic manipulator placed on a top level of the module. The manipulator may comprise a frame connected with a module, at least pair supporting rails and a bar movable along the supporting rails. Robotic arm connected with the bar. Plate handling gripper has a fork shape and may embrace MIC wings from 3 sides.

The robot comprises revolving rod, placed in a centre of turntable. Robotic arm connected with the rod. Said arm provided with simple plate handling gripper movable along the arm. Said gripper has a fork shape and may embrace microplate wings. Using the wings and/or slots simplify the gripper design. This embodiment does not require a big tolerance between the wings and gripper.

The biological module may comprise dispensing apparatus, robot and turntable arranged between centrifuge and analyzer. Turntable intends for placing MIC and microplates and adjusting this means near centrifuge sampling port.

The rapid centrifuge comprises:
a rotor, including a yoke, with a holding means for carrying at least one tube, said tube containing a blood sample and a gel separator, said holding means being pivotable with respect to the rotor;
the tubes holding means equipped with:
   a) centrifuge bucket and tubes adapter;
   b) means for tubes loading and unloading,
a means for rotation the rotor about a rotor axis to produce a centrifugal force having its vector radiating from the rotor axis, said centrifugal force is capable:
   a) to induce phase separation when the tube is pivoted in the first position in which the tube walls are inclined with respect to the vector of the centrifugal force;
   b) to allow complete gel seal when the tube is pivoted in the second position in which the tube walls are aligned with the vector of the centrifugal force;
   c) to remove caps from the tubes;
a displacing means to vary the location of the gravity center of the holding means together with the tube carried thereby during centrifugation;
a stopping means for maintaining a degree of inclination of the tube when it is pivoted in the said first position;
electro magnetically unit for operating the displacing means and tube removing means.

The centrifugation assembly may comprise a swing-out rotor centrifuge, while said rotor carries a yoke for mounting holding means (buckets) thereon. Said buckets comprise adapters for inserting the tube there into. The buckets are mounted on the yoke with possibility for swinging with respect to the yoke. The buckets may comprise the cap-removing insert.

The centrifugation assembly instead MIC may comprise a universal adapter configured to receive the tubes and to be inserted in the robot gripper and to analyzer loading means. Said adapter contains on an upper surface the cap-removing insert or plate. The said adapter provide with wings or slots and permitting to arrange the adapter on a robot gripper and analyzer carriage.

In accordance with the method of the rapid separation in a first stage tubes spin in inclined position to the vector of centrifugal force. This embodiment allows more rapid phase separation between serum, clot and gel. Tube inclination is significant factor in a liquids rapid separation. Centrifuge use variably inclination method for rapid separation. Inclination angle vary from 90 to 0 during same spin. Inclination degree depends from the kind of separated substance and design of inclination device. The method of the present invention recommended in a case of a whole blood to use a big (70-90) degree of tube initial inclination. In opposite in a case of a clot blood said method recommended small (0-30) degree of the tube inclination to the vector of centrifugal force.

The degree of inclination of the buckets is maintained by a stopping means comprises a cam mounted on the rotor. Said cam provided with at least one contact surface capable to lean against the buckets when buckets is pivoted in said first position so as to maintain the degree of inclination of the tubes. Said cam movable by centrifugal force or by using electro magnetically device.

After completing the first stage of the separation the common center of gravity of the buckets and of the tubes placed therein is displaced in the second position. During the second stage the centrifugal force urges the buckets with tubes to pivot into horizontal position in which they could have been aligned with the vector of the centrifugation force and thus the complete gel seal can take place. The stopping means does not prevent this pivoting movement. In the end of the second stage the centrifuge is stopped and the buckets and tubes return back into the initial position.

According to the present invention lowering the common center of the gravity of the buckets realize by displacing the adapter and tubes inside centrifuge bucket. The displacing means may be electro magnetically controlled. The movement of the adapter within the bucket can be affected in a controllable manner by using electromechanical sensor, timer and solenoids mounted on a centrifuge buckets. The sensor sends a signal to a self—aligning control system of the displacing means after beginning centrifugation and fixing means removing solenoid pins from the protruding position to relieve the adapter. The bucket provided with a springy means urging the adapter to move from a lowermost extremity of the bucket to an uppermost extremity.

The cap removing means is operated by virtue of the centrifugal force developed during the centrifugation run. Caps removing means may comprise:
Insert removable connected to an upper part of the centrifuge bucket, said insert being provided with a perforated partition transverse to the length of the tube, the diameter of at least one perforation of the partition fitting the outside diameter of the tube so as to allow insertion of the tube within the holding means through the perforation, and the cap having an outside diameter larger than the perforation diameter;
Adapter for supporting the tube after being inserted in to the bucket, said adapter movable by the centrifugal force along the longitudinal axis of the bucket from an uppermost position to a lowermost position,
A fixing means for preventing movement of the adapter by the centrifugal force from the uppermost position toward the lowermost position when the holding means is pivoted in the first position. The fixing means may be electro magnetically controlled,
A springy means for returning the adapter from the lowermost position into the uppermost position.

The tubes are movable within the adapter by the centrifugal force toward the lowermost position. The caps lean against the partition of the MIC or insert, so as to remove the caps from the tubes. In the lower part of the tubes adapter there is provided a common springy pad capable to protect tubes. After separation and cap removing Robot move away caps from centrifuge.

The aspect of the present invention is to use standard testing technology and existent compact analyzer. Compact analyzer includes standard parts like a reaction tank with reaction containers, reagent tanks with reagent containers, reagent pipettes and washing device. The example of a standard, compact analyzer shown in U.S. Pat. Nos. 6,042,786 and 6,500,388 assigned to Hitachi, Ltd. This analyzer may equip with a new multi-coordinate specimen probe and/or multi-coordinate carriage, which intends to MIC placing.

Robot load MIC with tubes inside the fast centrifuge buckets. Inner surface of the buckets fit an outside surface of the MIC, to allow inserting said MIC into the Centrifuge. After centrifuge spin robot move away cap removing plate or cap covering with caps from centrifuge.

This embodiment allows sucking a sample from tubes placed inside centrifuge and transferring specimen to Analyzer processing ring or to microplate's wells. After testing, robot removes MIC with tubes from centrifuge. After direct centrifuge testing disposable multi-cap is available for tube recapping and removing from centrifuge to storage. Disposable MIC, cap removing plate and cap covering is available to the present invention in a big Laboratory Automated Systems. Durable insert placed inside centrifuge bucket to support disposable MIC during centrifugation run.

Direct-centrifuge sampling method use indexing centrifuge rotor and turn away indexing probe. Said probe swing away from analyzer and moves above centrifuge sampling port. Centrifuge rotor indexed to plurality of rest positions to allow placing bucket with tubes near sample probe. Rotor turns in determinate angle and logical adjusts every tube under probe. Said probe suck sample from the tubes placed inside centrifuge. The example of analyzer equipped with turn away probe is standard ADVA 1650 assigned to Bayer Corporation.

Bar code reader or other Identification System registers batch number and LIS determinate specimen's volume and arrangement in a batch and send this information to module processor. Processor manages the analyzer probe movement regarding previously determine algorithms. Specimen probe equipped with a sample pipette, which let down in a certain depth and take a sample from a certain tube. In a next step a sample and a reagent are reacted with each other in a reaction container so as to analyze thus obtained reacted liquid.

LIS moves specimens throughout the FAAS for processing, completion of analytical results and to archive or disposal when processing is completed. The process control system includes a sophisticated scheduling module that follows the progress of the specimen throughout its automated pre-analytical processing, analytical, and post-analytical stages. LIS connects Hospitals and Physicians Offices with FAAS and rapidly supplies test results to physicians. The LIS use batch identification method to find the tube with a specimen that has previously testing. Operator then places said tube back to the module from storage if necessary.

The present invention in its various embodiments referring to the different groups above has only been summarized briefly. For better understanding of the present invention as well of its benefits and advantages reference will now be made to the following description of its embodiments taken in combination with the accompanying drawings.

### BRIEF DESCRIPTION OF THE DRAWINGS

FIG. 1a shows schematically the structure of Universal Laboratory Automated System.

FIG. 1b shows schematically the structure of Fast Automated Analytical Station.

FIGS. 2-11 show different embodiments of presented multi-item members.

FIG. 2 shows the MIC loaded inside the centrifuge bucket.

FIG. 3 shows the disposable MIC loaded inside the centrifuge bucket.

FIG. 4a shows 3 D view of the MIC with tubes after cap removing.

FIG. 4b shows 3 D view of the MIC with tubes after cap removing.

FIG. 5 shows universal adapter loaded inside the centrifuge bucket.

FIG. 6 shows 3 D view of the universal adapter with tubes after cap removing.

FIG. 7 shows the Multi-Item Plate loaded inside the centrifuge bucket.

FIG. 8 shows the disposable Multi-Item Plate loaded inside the centrifuge bucket.

FIG. 9 shows the microplate loaded inside the microplate adapter.

FIG. 10a shows 3 D view of Multi-Item Plate with tubes.

FIG. 10b shows 3 D view of Multi-Item Plate with caps.

FIG. 11a shows 3 D view of Multi-Cap with wings.

FIG. 11b shows 3 D view of Multi-Cap with slots.

FIGS. 12-22 show different embodiments of presented Analytical Module.

FIG. 12 shows the Maxi Clinical Analytical Module.

FIG. 13 shows the Clinical Analytical Module comprising two Analyzers.

FIG. 14 shows the Clinical Analytical Module comprising Conveyer.

FIG. 15 shows the Clinical Analytical Module comprising Tube Handler.

FIG. 16 shows the Biological Analytical Module using microplates sampling.

FIG. 17 shows 3 D view of presented Analytical Module and Robot.

FIG. 18 shows 3 D view of Mini Clinical Analytical Module and Robot.

FIG. 19 shows 3 D view of Biological Pre-Analytical Module and Robot.

FIG. 20 shows section view of combine Clinical Analytical Module.

FIG. 21 shows 3D view of combine Clinical Analytical Module.

FIG. 22 shows 3D view of combine Biological Analytical Module.

### DETAILED DESCRIPTION OF THE INVENTION

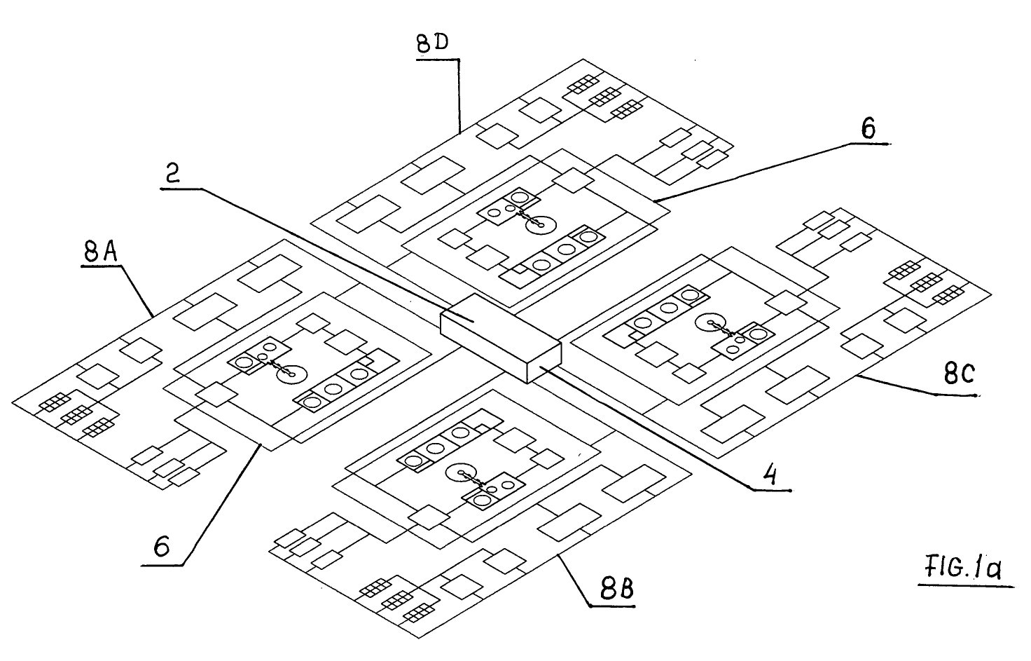

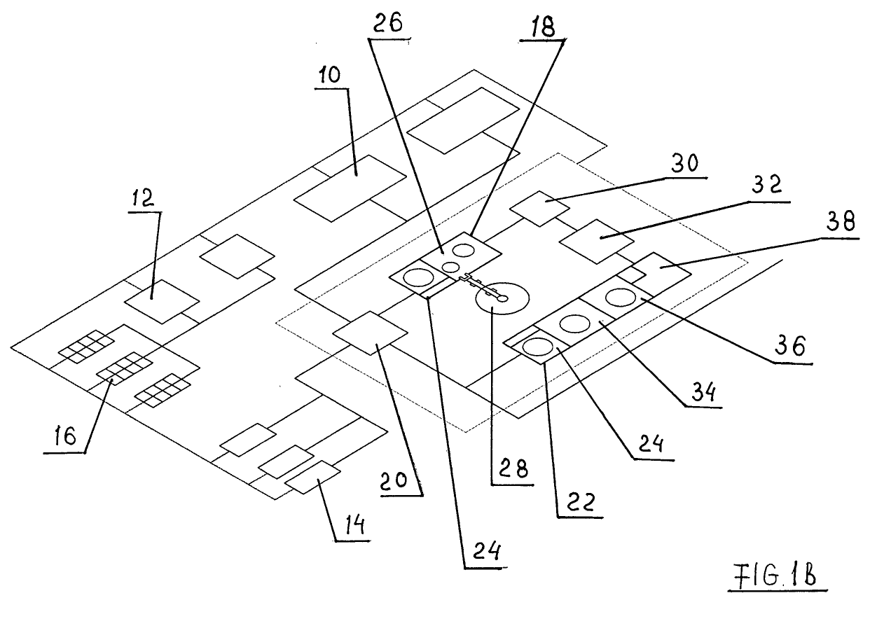

With reference to FIG. 1a and FIG. 1b the structure of Universal Laboratory Automated System will be briefly explained.

Main Laboratory (ML) 2 and General Information System (GIS) 4 are the High Level of the System.

Medium Level includes several Branches: A, B, C, D divided geographically in a country.

Every Branch include a main part: Local Information System (LIS) 6 and Fast Automated Analytical Stations (FAAS) 8 and a periphery: hospitals 10, physician offices 12, independent labs 14 and local blood taking stations 16. Local Information System LIS 6 connected with GIS 4.

Physicians 12 give orders and LIS 6 send patient to one of the local blood tacking stations 16. Some independent labs 14, stations 16 and hospitals 10 make centrifugation before sending tubes to FAS, to provide blood separation in a good time. In this cases tubes was previously sorted and loaded inside appropriated MIC.

Local Information System (LIS) 6 connect local FAAS 8, physician offices 12, independent labs 14 and blood taking stations 16 with ML 2 and GIS 4.

With reference to FIG. 1b the structure of Fast Automated Analytical Stations (FAAS) 8, will be briefly explained.

Automated Analytical Station 8 includes sorting deck 20; robotics units 28 and 34, centrifuge 24, dispensing unit 36, analyzers 26 and 38, recapping station 30, and storage area with refrigerator 32.

Centrifuge 24, analyzer 26 and robot 28 unite in clinical analytical module 18. Centrifuge 24, robot 34, dispensing unit 36 and analyzer 38 unite in biological analytical module 22. Bar code reading system, computer and electromechanical units do not show in this scheme. Each FAAS contains multi-item carriers for tubes placing, instead of standard tube racks.

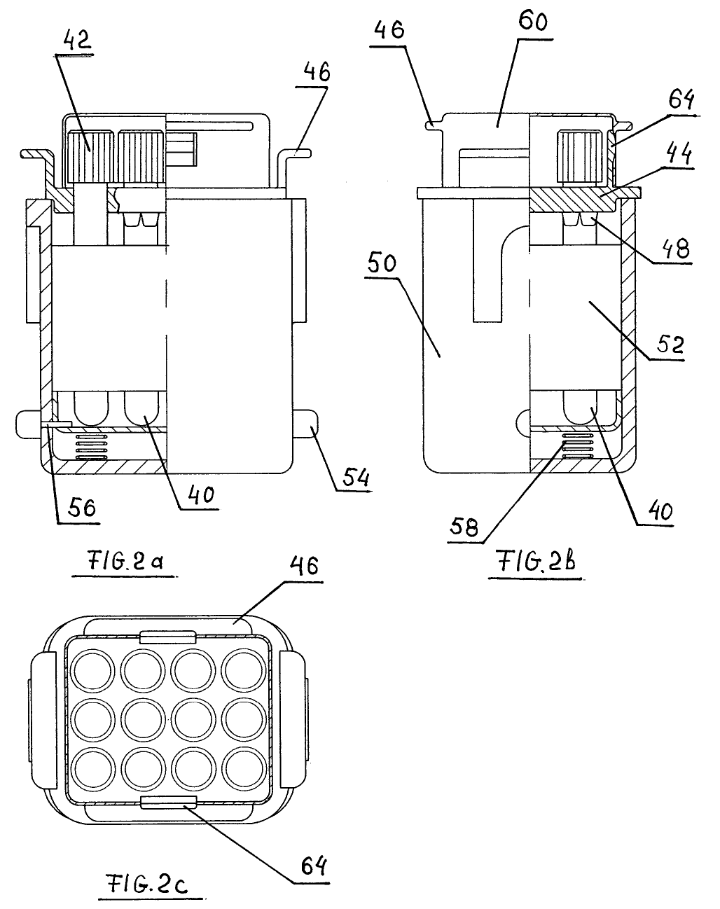

Now with reference to FIGS. 2 it will be explained how the adapter 52 lowering the common center of the gravity of the buckets 50. Also shown how caps 42 removing from the tubes 40 during centrifugation.

Tubes 40 sealed by caps 42 loaded inside multi-item carrier (MIC) 44 before centrifugation and cap removing. MIC 44 intends for transporting and placing with tubes 40 inside the centrifuge and analytical instrument. MIC 44 built in conjunction with wings 46 and deflectable clamps 48. Clamps 48 embrace tubes 40 and hold them during loading-unloading operations. Said horizontal wings 46, intends to arrange the carrier 44 on a robot gripper.

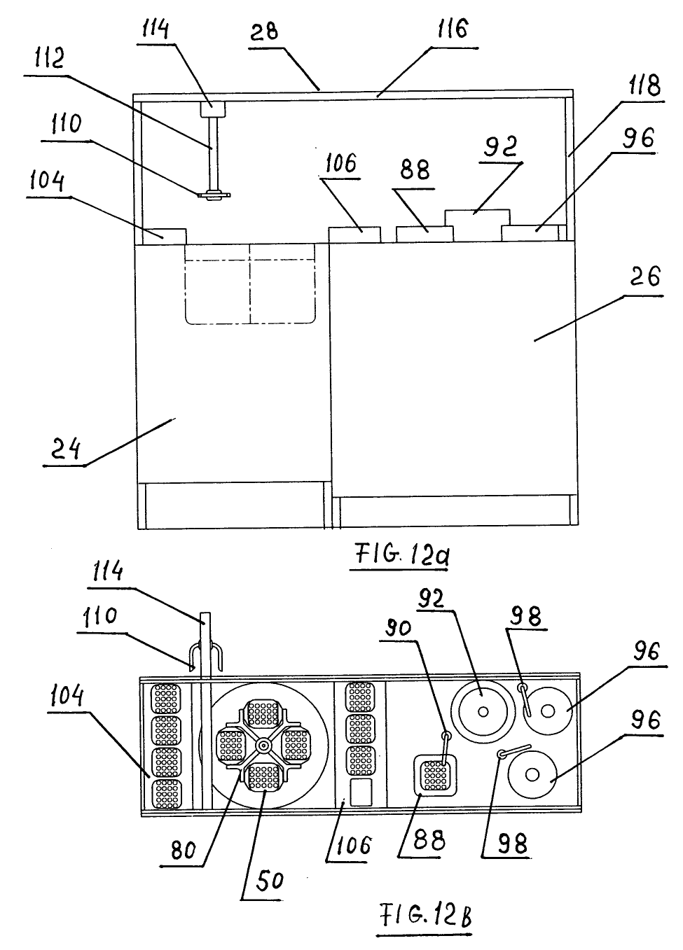

The centrifuge bucket 50 placed on a centrifuge rotor yoke (shown in FIG. 12). Adapter 52 placed inside bucket 50. On the outer side of the bucket 50 there is mounted a retaining means, for example a solenoid 54, capable to retain the adapter 52 proximate to the upper extremity of the bucket 50. In the lower part of the tubes adapter 52 there is provided a springy pad capable to protect tubes.

During the centrifugation run the adapter 52 is urged by the centrifugal force to move down and to take its lowermost position. The adapter 52 is supported by solenoid pins 56. After the separation is over the solenoids 54 remove the pins 56 from the protruding position to relieve the adapter 52. Now the centrifugal force urges the adapter 52 and the tubes 40 to move further and to reach the lowermost position. The common center of gravity displaced in the second position by the adapter 52 movements. The bucket 50 and tubes 40 takes the horizontal position. The tubes remain in this position until the gel seal is formed and separation is completed.

It can be appreciated that during the final stages caps 42 become removed from the tubes 40 due to the leaning against the partition of the MIC 44 by virtue of the centrifugal force developed during the centrifugation run.

Now the assembly is stopped and springs 58 return the adapter 52 in the uppermost position. The solenoids 54 urge the fixing pins 56 to protrude and to lock the uppermost position of the adapter 52. The multi-tube carrier 44 is ready for removing from the bucket 50.

Cap covering 60 have a springy compartments, which keep caps 42 during spin and unloading operation. The said cap covering 60 may be formed with a same outside horizontal wings 46, permitting to arrange the cap covering 60 on a robot gripper.

The said MIC 44 formed with extending up deflectable, springy catches 64. Catches 64 have thickened part that connects with an opening on a sidewall of cap covering 60. This embodiment lock caps 42 on a centrifuge holding means during spin vibration since the caps are reliably secured in covering compartments.

The robot (shown in FIG. 12) use same gripper to remove away cap covering 60 with caps 42 from carrier 44. Gripper move horizontally and embrace covering 60 wings 46. The gripper inner surface pres catches 64 thickened parts. After catches 64 releases covering 60, gripper move vertically and remove away covering with caps 42.

Robot places the carrier 44 with tubes on the analyzer or a waiting bench, after removing from the bucket 50.

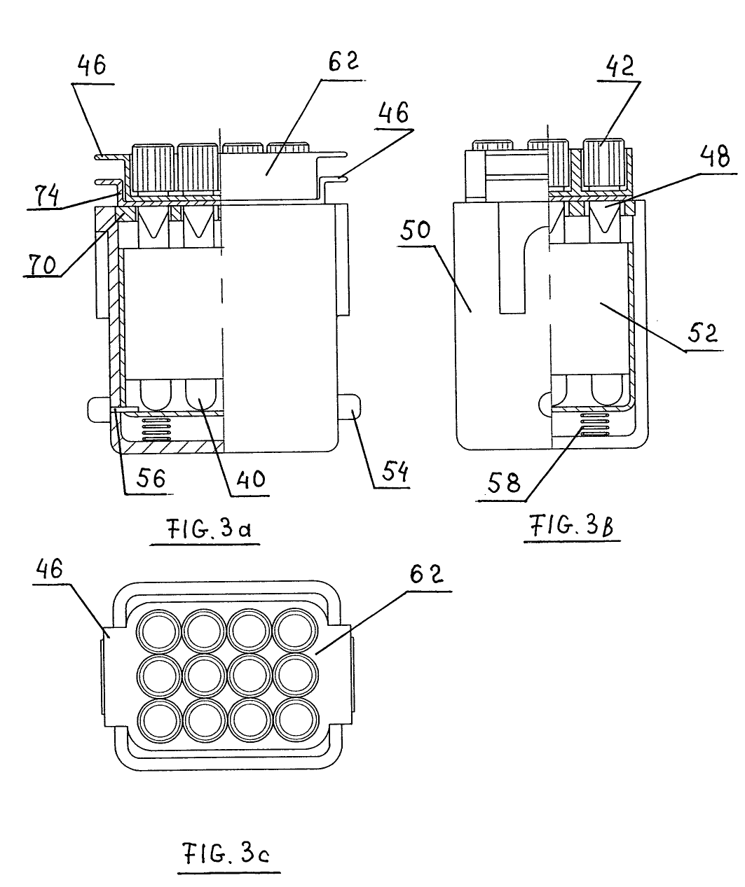

In FIG. 3 show the disposable multi-item carrier 74 connected with centrifuge bucket 50. Disposable cap removing plate 62 and tubes 40 sealed by caps 42 loaded inside multi-item carrier 74 before centrifugation and cap removing. MIC 74 intends for transporting by robot and placing with tubes 40 inside the centrifugation assembly and analytical instrument. MIC 74 built in conjunction with wings 46 and deflectable clamps 48. Clamps 48 embrace tubes 40 and hold them during loading-unloading operations. The said outside horizontal wings 46, permitting to arrange the carrier 74 on a robot gripper. Bucket 50 contains on an upper surface the cap-removing insert 70. Said insert 70 support MIC 74 during spin and cap removing. Caps 42 removing from the tubes 40 during centrifugation by the same means mentioned in previous embodiment.

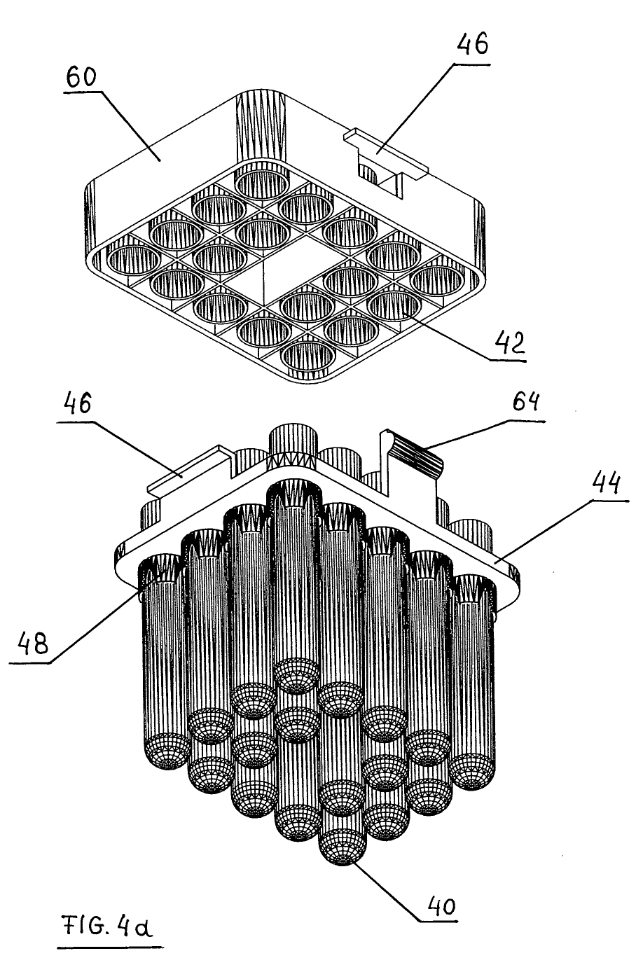

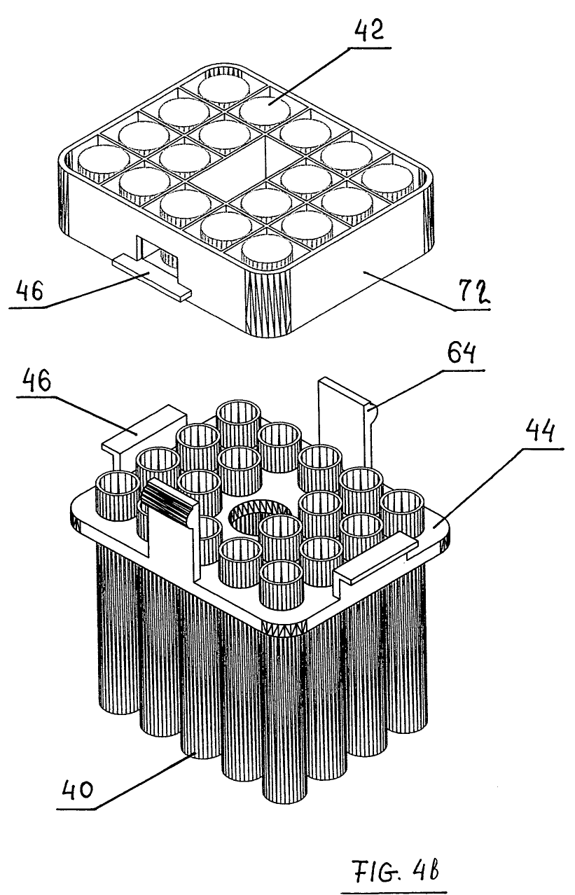

In FIG. 4 show 3 D view of the multi-tube carrier 44 with tubes 40 after cap removing. In FIG. 4a cap covering 60 moved away to show caps 42 inside their compartments. In FIG. 4b cap removing plate 72 with caps 42 moved away. Catches 64 connect with an opening on a sidewall of cap removing plate 72. This embodiment lock plate 72 and caps 42 on a centrifuge holding means during spin vibration since the caps are reliably secured in plate 72 compartments.

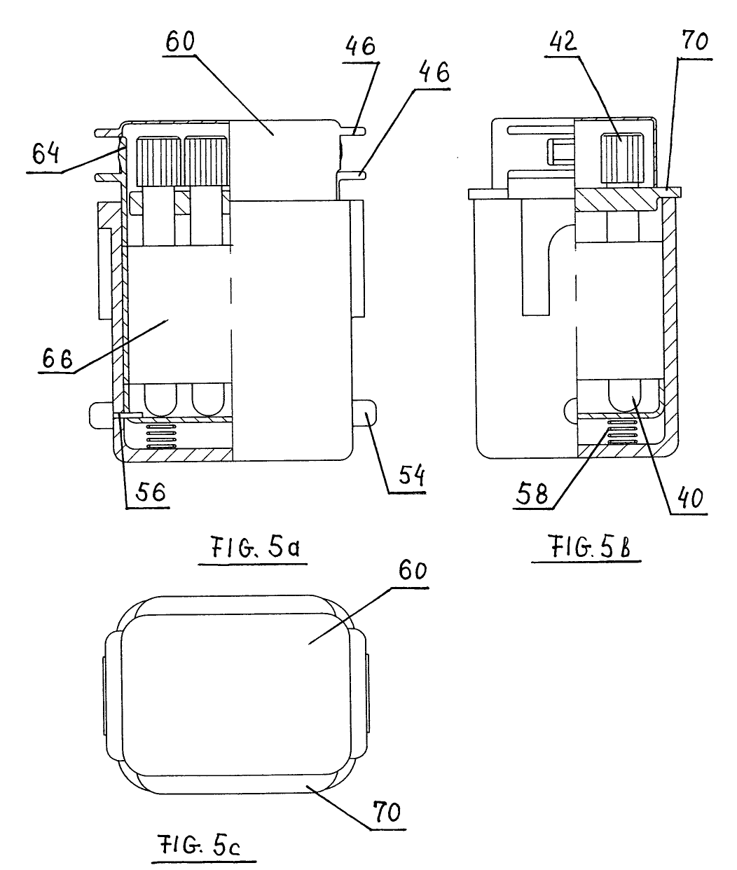

In FIG. 5 show additional embodiment of the present invention, which employs universal adapter 66 provided within the bucket 50. In this embodiment the adapter 66 comprises wings 46, which are similar to that of the FIG. 2. Said wings 46 are fixedly secured in the upper part of the adapter 66. Said adapter 66 contains on an upper surface the cap-removing insert 70. During the centrifugation run the adapter 66 is urged by the centrifugal force to move down and to take its lowermost position. The adapter 66 is supported by solenoid pins 56 and springs 58 capable to return the adapter along the bucket from its lowermost position to the initial position.

After the separation is over the solenoids 54 remove the pins 56 from the protruding position to relieve the adapter 66. Now the centrifugal force urges the adapter 66 and the tubes 40 to move and to reach the lowermost position. The common center of gravity displaced in the second position by the adapter 66 movements. The bucket 50 and tubes 40 takes the horizontal position. The tubes remain in this position until the gel seal is formed and separation is completed.

It can be appreciated that during the final stages caps 42 become removed from the tubes 40 due to the leaning against the partition of a cap-removing insert 70 by virtue of the centrifugal force developed during the centrifugation run.

Now the assembly is stopped and springs 58 return the universal adapter 66 in the uppermost position ready for removing from the bucket 50. The solenoids 54 urge the fixing pins 56 to protrude and to lock the uppermost fixing position of the adapter 66.

The said adapter 66 may be formed with extending up deflectable, springy catches 64. Catches 64 have thickened part that connects with an opening on a sidewall of cap covering 60. This embodiment lock caps 42 on a centrifuge holding means during spin vibration since the caps are reliably secured in covering compartments.

The robot (shown in FIG. 12) use same gripper to remove away cap covering 60 with caps 42 from universal adapter 66. Gripper move horizontally and embrace covering 60 wings 46. The gripper inner surface pres catches 64 thickened parts. After catches 64 releases covering 60, gripper move vertically and remove away covering with caps 42.

Before removing adapter 66 from centrifuge, the solenoids 54 remove the pins 56 from the protruding position to relieve the adapter 66. Robot places the universal adapter 66 with tubes on the Analyzer carriage or a waiting bench, after removing from the bucket 50.

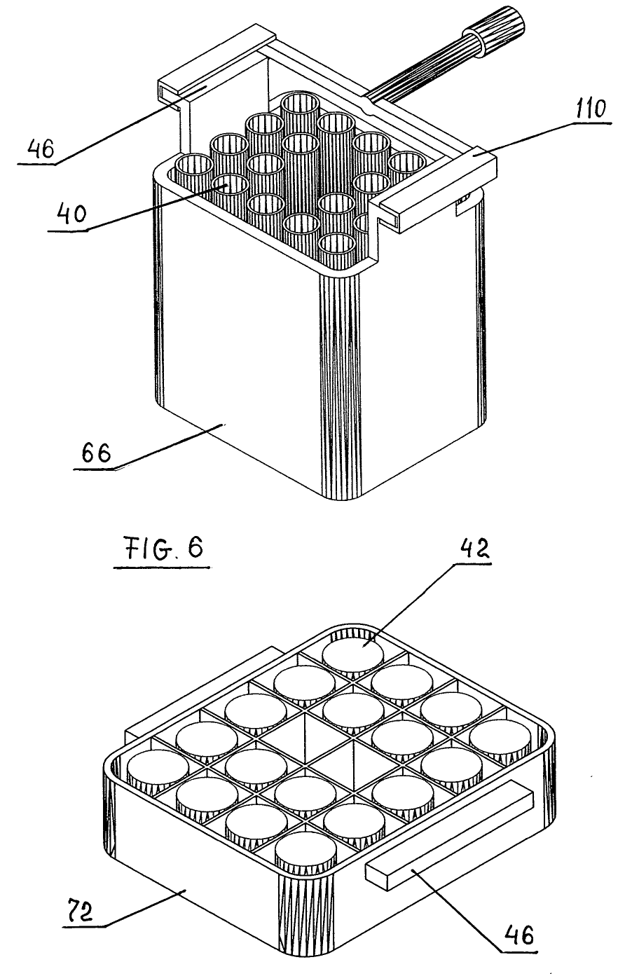

In FIG. 6 show 3 D view of the universal adapter 66 with tubes 40 after cap removing. In this embodiment uses multi-item plate 72 for caps 42 removing and moving away. Plate 72 has springy compartments, which keep caps 42 during spin and unloading operation. This embodiment allows using plate 72 to remove away caps 42 from centrifuge after spin is over. The said plate 72 formed with outside horizontal wings 46, permitting to arrange the plate 72 on a robot gripper. Said plate 72 with caps 42 inside their compartments moved away from adapter 66 by using robot gripper 10.

It should be understood that in the embodiments shown in FIGS. 2-6 there can be implemented either rapid separation or removal of the caps or both. It can be realized that this embodiment does not require taking the tubes out of the multi-tube carrier 44 or universal adapter 66 for cap removing and testing.

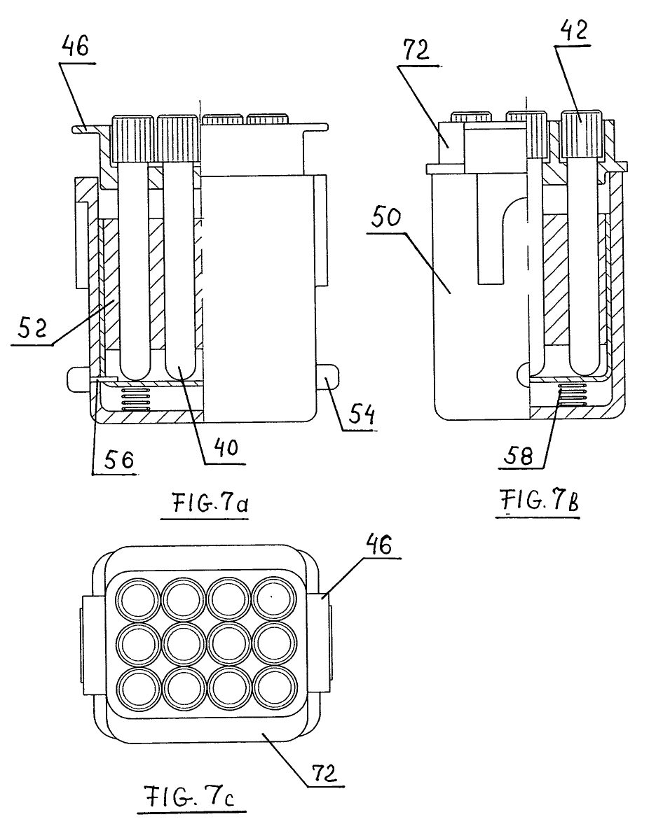

In FIG. 7 show multi-item plate 72 with tubes 40 sealed by caps 42 loaded inside centrifuge bucket 50 before centrifugation and cap removing.

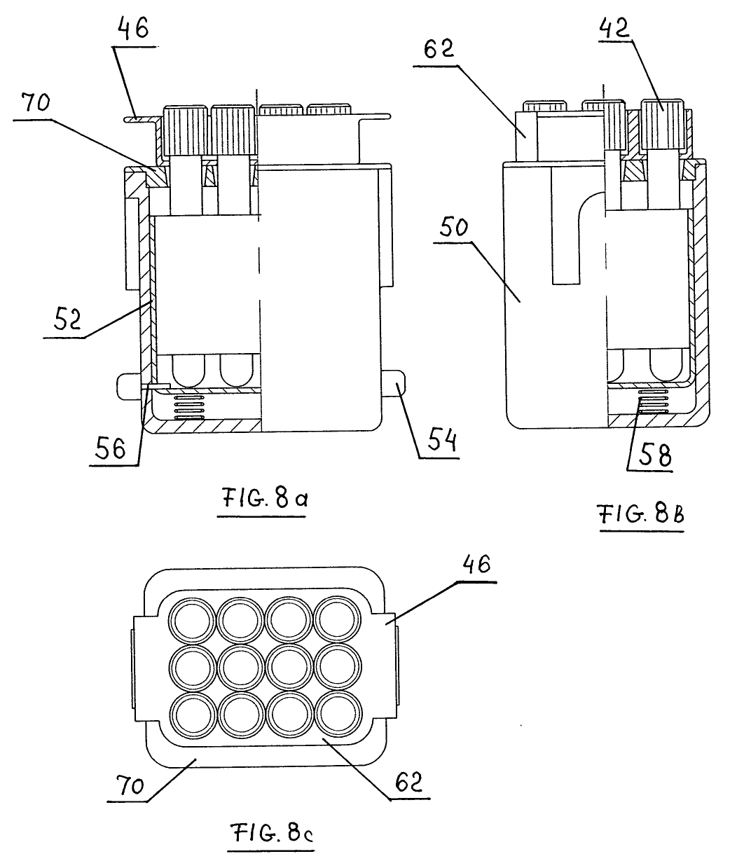

In FIG. 8 show disposable multi-item plate 62. In this embodiment rigid insert 70 loads inside bucket 50 to support plate 62.

Plates 72 or 62 uses in direct centrifuge sampling method, for tubes 40 loading and cap 42 removing during centrifugation spin. Said plates intends for transporting tubes 40 with caps 42 by robot and placing inside the centrifugation assembly. Plate 72 or 62 embrace caps 42 and hold tubes 40 during loading operations. Said plates 72 and 62 formed with outside horizontal wings 46, permitting to arrange it on a robot gripper.

It can be appreciated that during the final stages caps 42 become removed from the tubes 40 due to the leaning against the partition of the multi-item plate 72 or 62 by virtue of the centrifugal force developed during the centrifugation run. Multi-item plates 72 and 62 have springy compartments, which keep caps 42 during spin and loading operation. This embodiment allows using multi-item plates 72 and 62 to remove away caps 42 from centrifuge after spin is over. Robot use simply gripper to remove away plates 72 or 62 with caps 42. Gripper move horizontally and embrace wings 46. After this gripper move vertically and remove away plate 72 or 62 with caps 42.

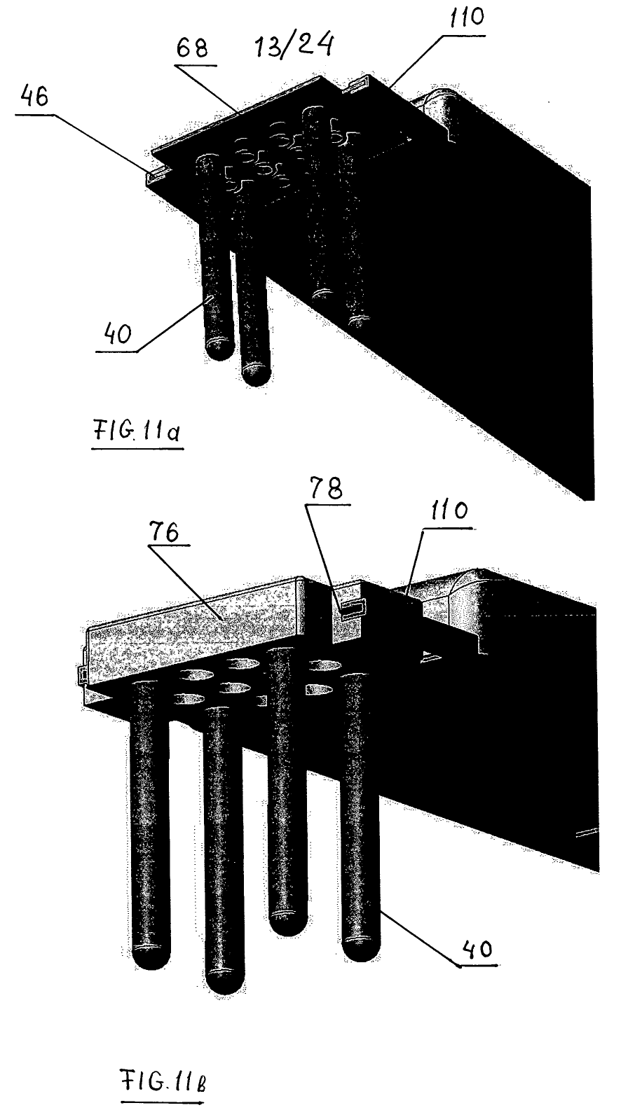

It should be understood that in the embodiments shown in FIGS. 7 and 8 there can be implemented both rapid separation, caps removing and direct centrifuge sampling. It can be realized that this embodiment allow taking the tubes out of the centrifuge adapter 52 after specimen sampling by using multi-caps 68 or 76 shown in FIGS. 11a and 11b.

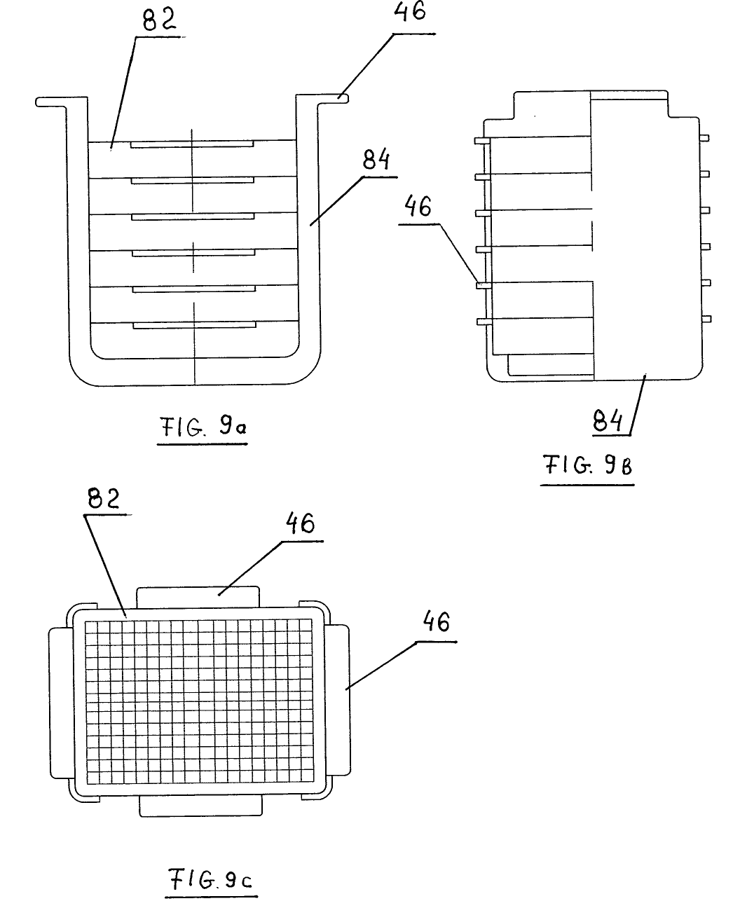

In FIG. 9 show microplates 82 loaded inside microplate adapter 84. Adapter 84 intends for microplates 82 placing and loading within the centrifuge bucket 50. Microplate 82 provided at least a pair protrusions—wings 46 or slots 78 on side walls, permitting to arrange the carrier on a robotic simply plate handling gripper.

Adapter 84 provided with a hollow body. Inner surface of this body fit an outside surface of the microplate 82 to allow inserting at least one microplate 82 into the adapter 84. Sidewalls of the adapter 84 provides with at least two openings permitting microplates wings 46 protrude from said walls. Robotic simply plate handling gripper load microplates 82 inside adapter 84. Adapter 84 provided at least a pair protrusions—wings 46 or slots 78 on side walls, permitting to arrange the adapter on a robotic simply plate handling gripper.

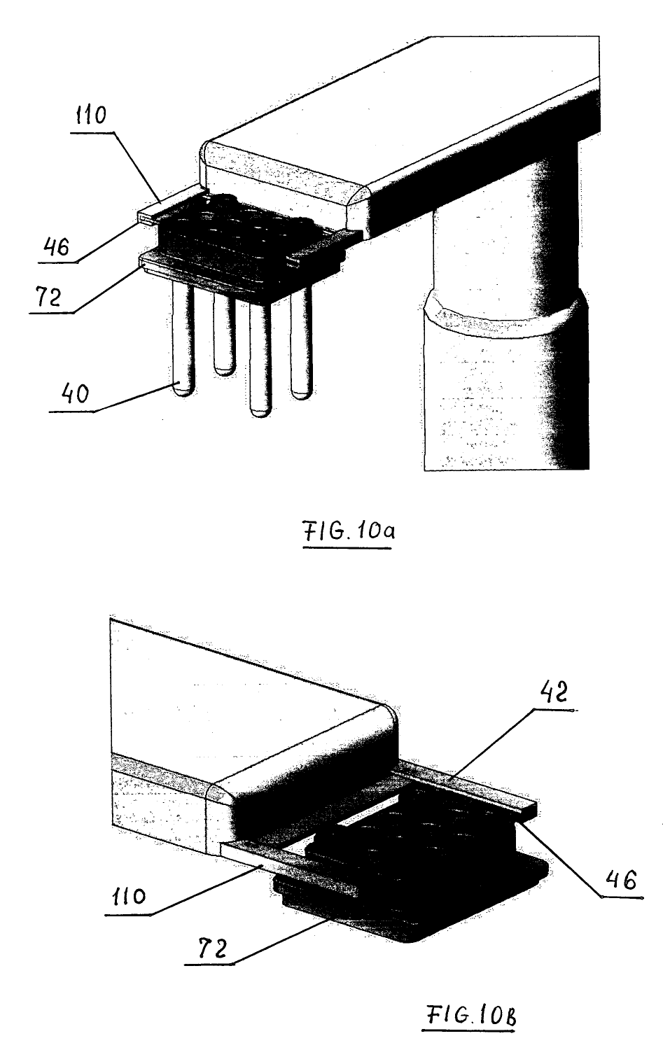

In FIG. 10a show 3 D view of robot gripper 110 loaded multi-item plate 72 with tubes 40 inside centrifuge.

In FIG. 10b show 3 D view of robot gripper 110 move away multi-item plate 72 with caps 42 from centrifuge after cap removing.

In FIG. 11a show 3 D view of robot gripper 110 move away multi-cap 68 with tubes 40 from centrifuge after testing. Robot takes empty multi-cap 68 by wings 46, connects it with tubes 40 and move away.

In FIG. 11b show 3 D view of robot gripper 110 move away another embodiment of multi-cap 76 with tubes 40 from centrifuge after cap removing and testing. Multi-Cap 76 formed with outside horizontal slots 78 for gripper 110 arrangements.

Multi-caps 68 or 76 use to remove tubes 40 from module after sampling and testing.

In FIGS. 12-22 the principle of the different embodiments of the analytical module will be briefly explained.

With reference to FIG. 12 show clinical module 18 comprises coupling centrifuge 24 and compact analyzer 26 having common working area and adjusted each other. Robot takes multi-tube carriers 44 from sorting deck 20 and place in centrifuge waiting bench 104. Centrifuge 24 in its inner part contains a rotor 80 dedicated for buckets 50 placing. When centrifuge lid is open robot 28 take carriers 44 with tubes 40 and place inside buckets 50. This embodiment allows arranging centrifuge 24 near analyzer 26 and do not required rotor 80 indexing. Rotor 80 contains transmitters for determination buckets 50 position. Robot 80 lowers arm 112 inside centrifuge inner area and turns the gripper 110 to the bucket 50 direction. After separation and decaping robot 28 removes away cap coverings 60 with caps 42 from multi-tube carriers 44 and transfer said carriers 44 to analyzer waiting bench 106.

Compact analyzer 26 includes standard parts like a reaction tank 92 with reaction containers, reagent tanks 96 with reagent containers, reagent pipettes 98 and washing device (not shown). Analyzer 26 provided with multi-coordinate specimen probe 90 and bidirectional carriage 88, which intends for multi-tube carrier 44 placing. Carriage 88 configured with the sides similar to that of the multi-tube carrier 44 so as to enable insertion of the carrier within the carriage 88. Carriage 88 may have revolve and/or prismatic far and wide movement regarding analyzer specimen probe 90.

Said module 18 uses direct multi-tube carriers 44 sampling method. Since multi-tube carriers 44 with tubes 40 loaded in carriage 88 a specimen probe 90 takes sample from tubes 40 in a logical manner and transfer it to analyzer processing ring 92. Bar code reader registers bar code label placed on the carrier 44 and LIS determinate specimen volume and tube arrangement in the said carrier.

Robotic manipulator 28 placed in a top of the module 18. The manipulator 28 comprise a frame 118 connected with a module 18, at least pair supporting rails 116 and a bar 114 movable along the supporting rails 116. Robotic arm 112 moves lengthways the bar 114. The robot gripper 110 configured like a fork and has a groove in an inner part to receive wings 46. Plate handling gripper 110 embraces the wings 46 by its inner surface. The wins lean 46 in a surface of gripper groove.

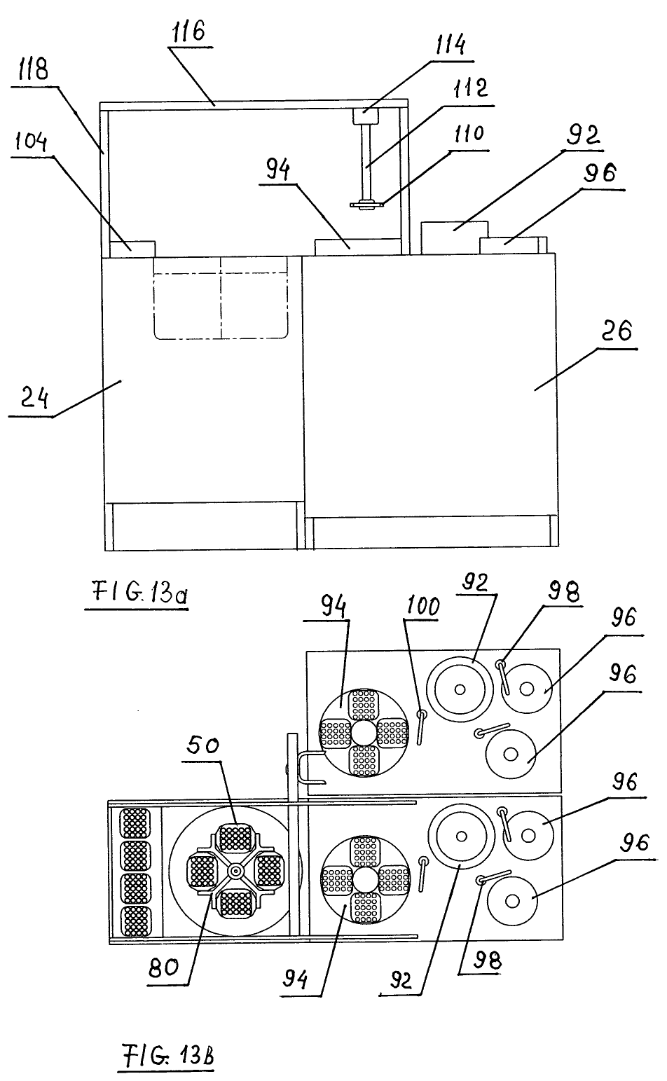

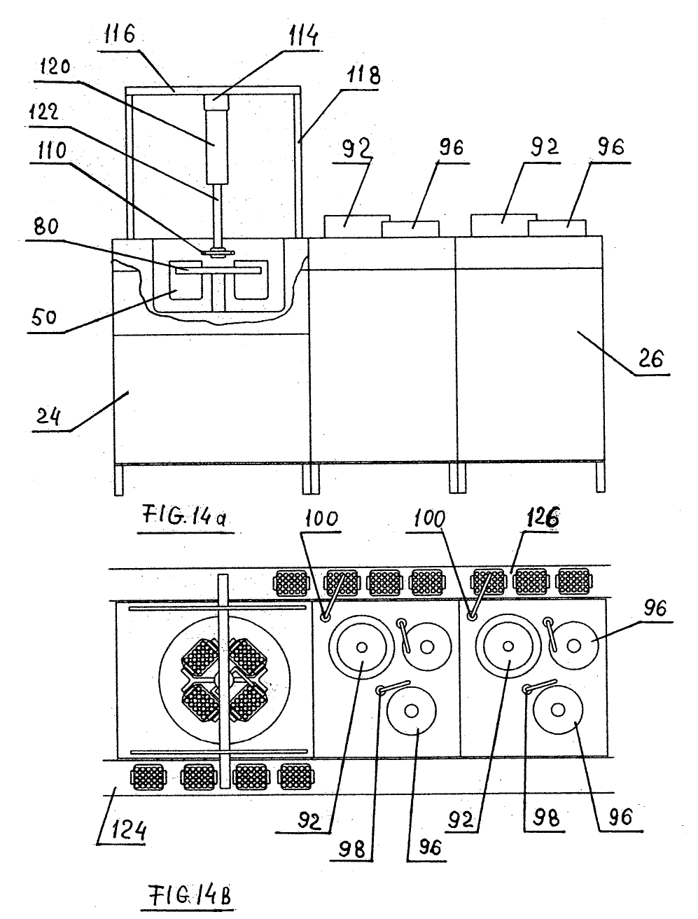

With reference to FIG. 13 shows, clinical automated analytical module 18, with at least two automatic clinical analyzers are linked together. Module 18 comprises coupling centrifuge 24, robot 28 and a pair analyzers 26 having specimen carousel 94 for MIC loading. Robotic manipulator 28 placed in a top of the module 18. Robotic arm 112 comprises base 120 and rod 122 movable inside said base 120.

Centrifuge 24 in its inner part contains a rotor 80 for buckets 50 placing. When centrifuge lid is open, robot 28 take carriers 44 with tubes 40 from centrifuge waiting bench 104 and place inside buckets 50. After separation and decaping robot 28 removes away cap coverings 60 with caps 42 from multi-tube carriers 44 and transfer said carriers 44 to first analyzer 26. Indexing carousel 94 provided with compartments for loading MIC.

Since multi-tube carriers 44 with tubes 40 loaded in carousel 94 swinging indexing probe 100 takes specimen from tubes 40 in a logical manner and transfer it to analyzer processing ring 92. Bar code reader register bar code label placed on the carrier 44 and LIS determinate specimen volume and arrangement in the batch.

After providing test in a first analyzer 26 robot transfer said MIC to second analyzer.

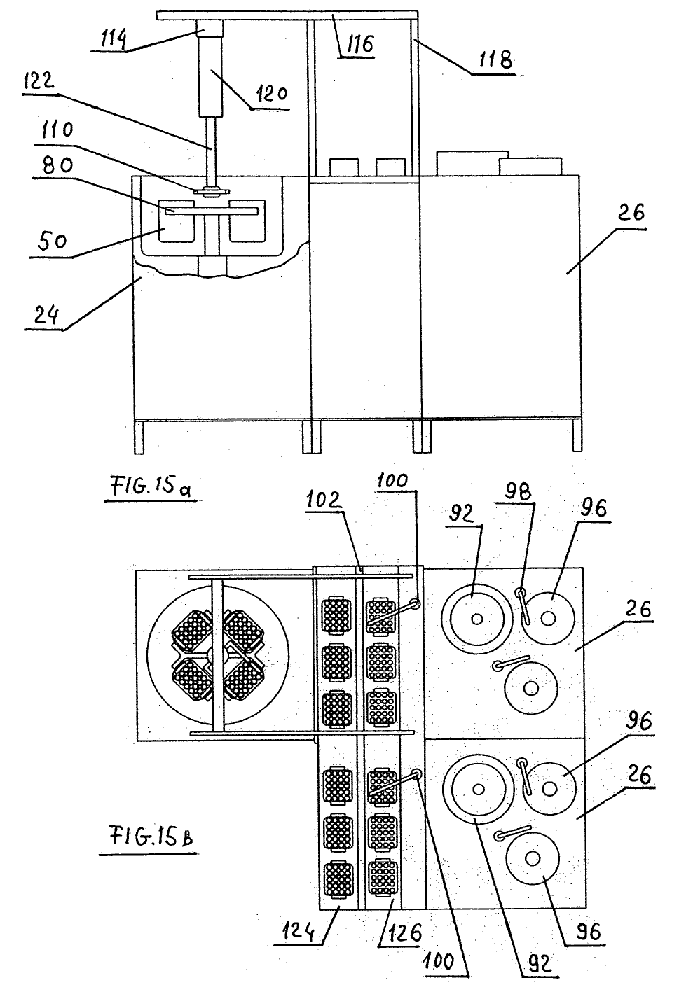

With reference to FIG. 14 the module 18 comprises outer conveyer tracks 124 and 126 formed integrally with centrifuge 24, at least a pair clinical analyzers 26 and a robot 28. Compact analyzer 26 includes standard parts like a reaction tank 92 with reaction containers, reagent tanks 96 with reagent containers, reagent pipettes 98 and washing device. Analyzer 26 equips with swinging out indexing probe 100 for direct track sampling from tubes loaded inside MIC 44 on track 126.

The conveyer loading track 124 and unloading track 126 arranging near the module 18. Conveyer track 124 connected module 22 with the sorting deck 20. Sorting deck 20 equip with robot, which place tubes 40 inside multi-tube carriers 44 and place said carriers with tubes 40 in the loading track 124.

Centrifuge 24 in its inner part contains a rotor 80 for buckets 50 placing. When centrifuge lid is open, robot 28 take carriers 44 with tubes 40 from loading track 124 and place inside buckets 50. After separation and decaping said robot 28 transfer carriers 44 to unloading track 126. Robot 28 removes away cap coverings 60 or plate 72 with caps 42 from multi-tube carriers 44.

Tracks 124 and 126 configured with the compartments similar to that of the multi-tube carrier 44 so as to enable insertion of the carriers inside conveyer. Since multi-tube carriers 44 with tubes 40 loaded in track 126 swinging out indexing specimen probe 100 takes sample from tubes 40 in a logical manner and transfer it to analyzer processing ring 92. Bar code reader register bar code label placed on the carrier 44 and LIS determinate specimen volume and arrangement in the batch.

With reference to FIG. 15 the module 18 comprises handler 102 formed integrally with centrifuge 24, a pair of clinical analyzers 26 and a robot 28. Handler 102 may equip with multi-coordinate specimen probe 90 or swing out indexing probe 100. Compact analyzer 26 includes standard parts like a reaction tank 92 with reaction containers, reagent tanks 96 with reagent containers, reagent pipettes 98 and washing device.

The handler 102 includes loading conveyer 124 and unloading conveyer 126 arranging within the interior of the handler 102. Conveyer track 124 connected handler 102 with the sorting deck 20. Sorting deck 20 equip with robot, which place tubes 40 inside multi-tube carriers 44 and place said carriers with tubes 40 in the loading track 124.

Centrifuge 24 in its inner part contains a rotor 80 for buckets 50 placing. When centrifuge lid is open, robot 28 take carriers 44 with tubes 40 from loading conveyer 124 and place inside buckets 50. After separation and decaping said robot 28 transfer carriers 44 to unloading conveyer 126. Robot 28 removes away cap coverings 60 or plate 72 with caps 42 from multi-tube carriers 44. Tracks 124 and 126 configured with the compartments similar to that of the multi-tube carrier 44 so as to enable insertion of the carriers inside conveyers.

Since multi-tube carriers 44 with tubes 40 loaded on conveyer 126 specimen pipette 90 or 100 takes sample from tubes 40 in a logical manner and transfer it to analyzer processing ring 92. Bar code reader register bar code label placed on the carrier 44 and LIS determinate specimen volume and arrangement in the batch.

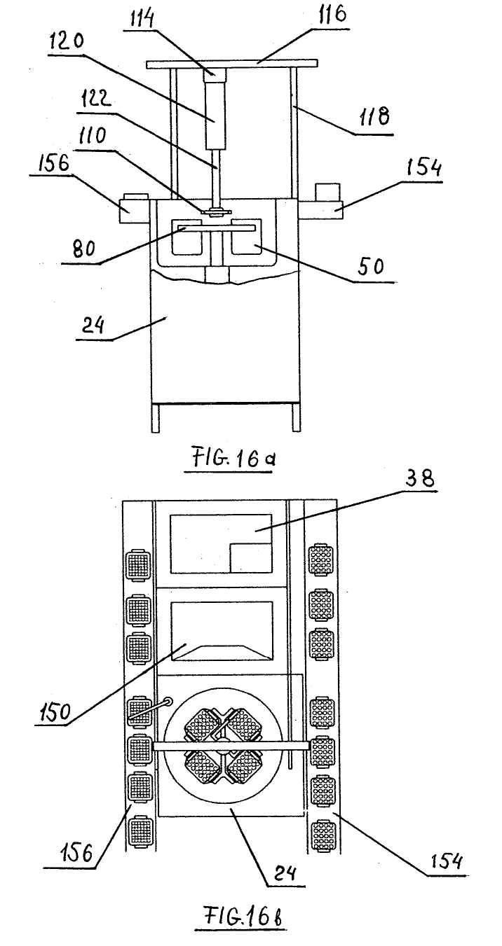

With reference to FIG. 16 biological module 22 comprises centrifuge 24, plate hotel and chiller 150, biological analyzer 38 and a robot 28.

The module 22 comprises outer conveyer tracks 154 and 156 formed integrally with centrifuge 24. Track 154 intends to MIC 44 loading and unloading. Conveyer track 154 connected module 22 with the sorting deck 20. Sorting deck 20 equip with robot, which place tubes 40 inside multi-tube carriers 44 and place said carriers with tubes 40 in the loading track 124. Track 156 intends to microplate 82 loading, sampling and unloading.

Robotic manipulator 28 placed in a top and connected module 22 with sorting deck 20, plate hotel 150 and biological analyzer 38. When centrifuge lid is open, robot 28 take carriers 44 with tubes 40 from track 154 and place inside buckets 50. After separation robot 28 removes away cap coverings 60 or plate 72 with caps 42 from multi-tube carriers 44.

Centrifuge 24 provided with indexing rotor 80 and swing out probe 100 for direct centrifuge sampling. Since robot 28 place microplates 82 on track 156, swing out probe 100 takes sample from tubes 40 in a logical manner and transfer it into microplates 82 wells. Bar code reader register bar code label placed on the microplates 82 and LIS determinate specimen arrangement in the array. After adding reagent, robot 28 takes microplates from track 156 and place inside plate hotel and chiller 150 or biological analyzer 152.

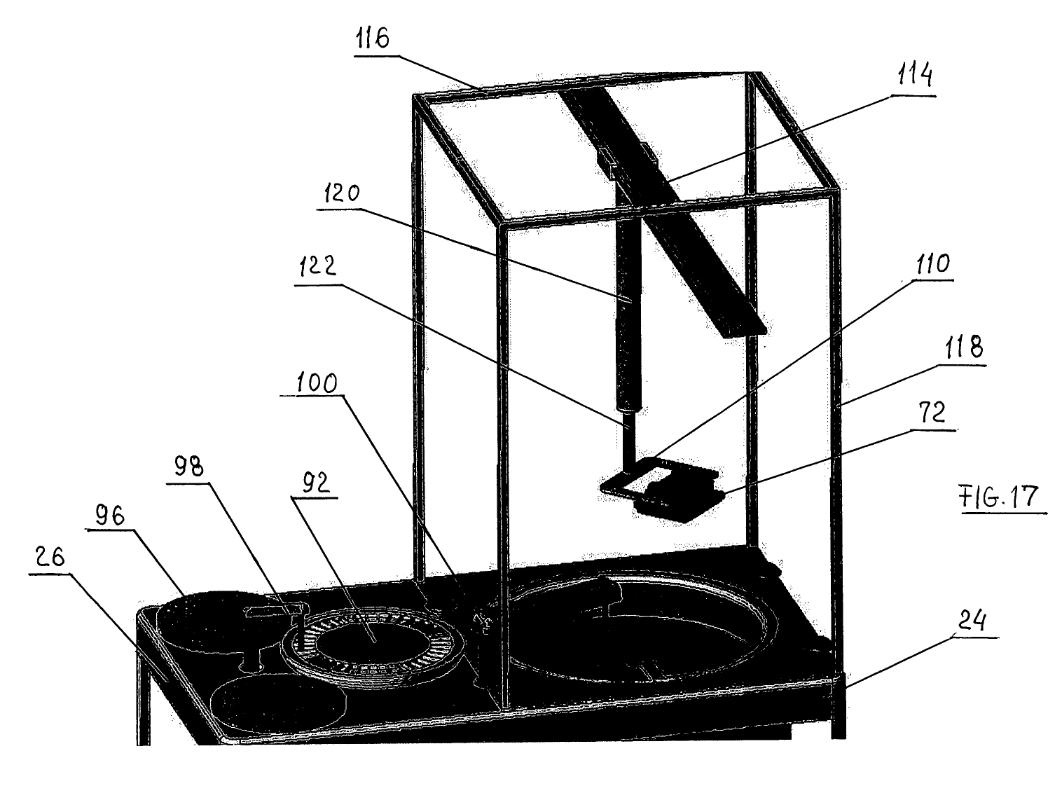

With reference to FIG. 17 show 3 D view of clinical module 18. Robotic manipulator 28 placed in a top of the module 18. The manipulator 28 comprise a frame 118 connected with a module 18, at least pair supporting rails 116 and a bar 114 movable along the supporting rails 116. Robotic arm 112 comprises base 120 and rod 122 movable inside said base 120. The robot gripper 110 configured like a fork and move away cap removing plate 72 with caps 42. Centrifuge provided with indexing rotor 80 for direct centrifuge sampling. Swing out probe 100 takes sample from tubes 40 in a logical manner and transfer it to analyzer processing ring 92. Bar code reader register bar code label placed on the carrier 44 and LIS determinate specimen volume and arrangement in the batch.

After testing, robot 28 takes MIC 44 or universal adapter 66 by wings and move away from module to recapping station arranged near the module. In the recapping station (not shown) robot 28 place multi caps 68 or 76 on the MIC 44 or adapter 66 and remove tubes 40 to the storage refrigerator 32.

This module intends to small laboratories and able to work in conjunction with sorting deck 20 and refrigerator storage 32 in a real time regime.

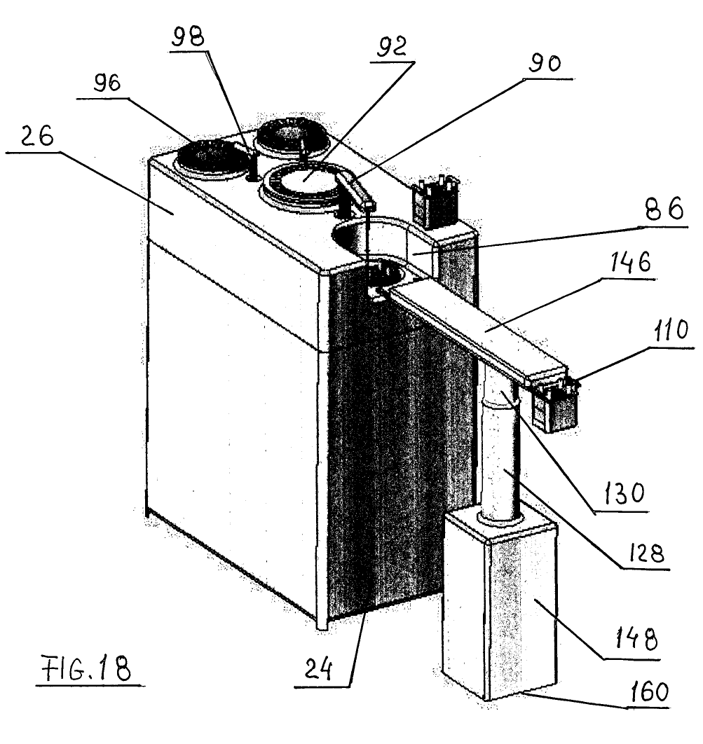

With reference to FIG. 18 show 3 D views of mini clinical module 18 assembling with out standing robotic manipulator 160. Module 18 contains clinical analyzer 26 coupling with centrifuge 24.

The interior of the module 18 may contain common refrigerator and motor. The module 18 includes loading-unloading port 86 arranging within the interior of the analyzer 26. Centrifuge 24 equipped with automated opening and closing lid and contains adapter lifting mechanism. By virtue of this provision the adapter 66 or multi-tube carrier 44 lifting automatically from centrifuge inner area 82 to the loading-unloading port 86.

Compact analyzer 26 includes standard parts like a reaction tank 92 with reaction containers, reagent tanks 96 with reagent containers, reagent pipettes 98 and washing device (not shown). This embodiment allows arranging analyzer 26 above centrifuge 24 and decreases the module 18 sizes. Module 18 comprises multi-coordinate specimen probe 90 and centrifuge 24 provided with indexing rotor 80 for direct centrifuge sampling. Said probe 90 suck specimen from the tubes placed inside centrifuge and drop it in the analyzer reaction containers.

Assembly use robot 160 with one combine revolve and prismatic joints for arm and two prismatic joints for grippers. Robot 160 consists of basis 148, base 128, Rode 130, Arm 146 and two grippers 110. Robot 160 takes MIC 44 or universal adapter 66 or multi-item plate 72 with tubes 40 and load inside centrifuge 24.

When centrifuge lid is open and adapter lifted in the port 86 area, robot 160 take carriers 44 with tubes 40 from sorting deck and place inside adapters. Centrifuge rotor 80 turn on 90 degree and other bucket 50 lift in port 86 area. Robot 28 takes a next MIC 44 and put inside adapter. After loading two or four MIC 44, centrifuge 24 spins them, around 1 min for separation serum, clot and gel and for caps 42 removing. Now the rotor 80 is stopped and first adapter 66 returns to its upper position in the port 86. Robot 160 moves away cap-covering 60 or plate 72 with caps 42 for direct centrifuge sampling.

Multi-coordinate specimen probe 90 takes a sample from tubes 40 placed inside adapter 66 in the port 86. Specimen probe 90 takes samples from tubes 40 in a logical manner and transfers it to reaction containers in the ring 92. Analyzer begins processing and testing since first specimen reaches the said reaction container. Bar code reader register bar code label placed on one or two tubes and LIS determinate specimen arrangement in the all batch. At this time rotor 80 turn on 90 or 180 degree and other adapter 66 with next separated tubes 40 lift in the port 86 areas. After sampling all tubes 40 in the MIC 44 robot 160 remove MIC 44 from module 18 to recapping station 30. Robot takes the new MIC 44 within tubes 40 from sorting deck 20 and place inside empty adapter lifted in a port 86.

Said mini module 18 does not require waiting area in a working surface since sorting deck, centrifuge, compact analyzer and robot logically operate tubes arriving to the laboratory. This assembly intends to small laboratories and able to work in conjunction with sorting deck 20 and refrigerator storage 32 in a real time regime

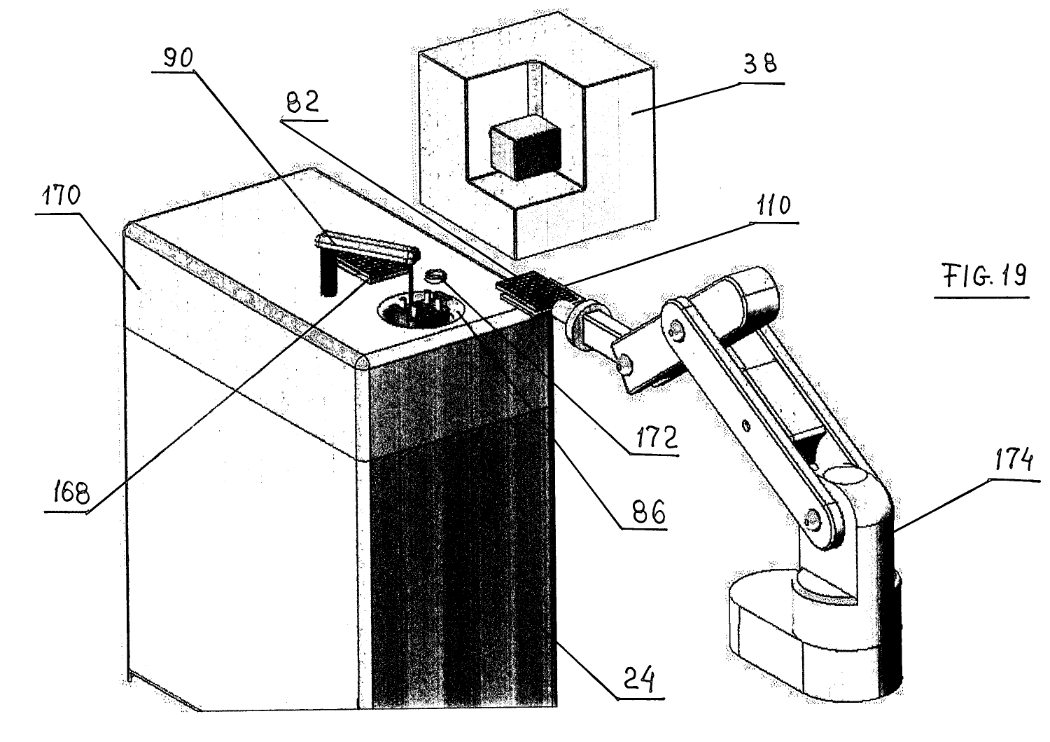

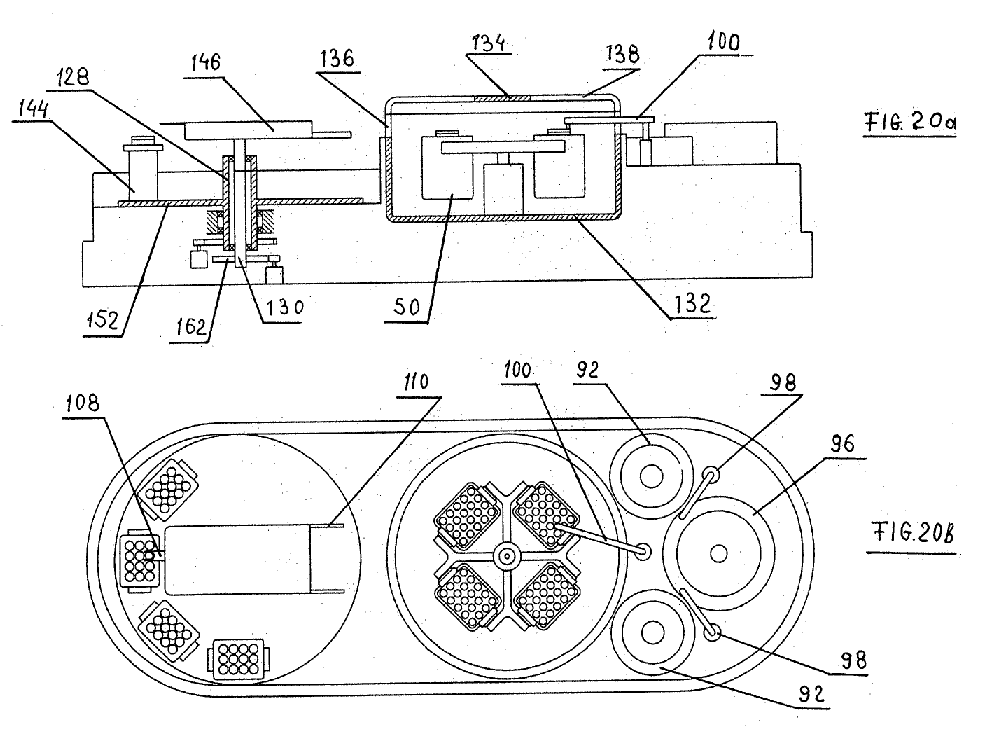

With reference to FIG. 19 show 3 D views of pre-analytical module 170 assembling with biological analyzer 38, plate hotel (not shown), dispersing unit (not shown) and out standing serial robot 174 with six single degree of freedom joints.

Module 170 contains centrifuge 24, multi-coordinate specimen probe 90, washing device 172 and microplate carriage 168. The centrifuge 24 contains loading-unloading port 86 arranging near of the carriage 168. Centrifuge 24 equipped with automated opening and closing lid and contains adapter lifting mechanism. By virtue of this provision the adapter 66 or multi-tube carrier 44 lifting automatically from centrifuge inner area to the loading-unloading port 86. Robot 174 provided with one universal gripper 110. Robot 174 takes MIC 44 or Universal Adapter 66 or Multi-Item Plate 72 with tubes 40 and load inside centrifuge 24.

Centrifuge provided with indexing rotor 80 for direct centrifuge sampling. After separation and cap removing probe 90 suck specimen from the tubes 40 placed inside carrier 44 or universal adapter 66 and drop it in the microplates 82, places on carriage 168. Specimen probe 90 takes samples from tubes 40 in a logical manner and transfers it to microplates wells. After sampling robot 174 remove microplate 82 from carriage 168 and put inside analyzer 38 or plate hotel 150. At this time rotor 80 turn on 90 or 180 degree and other adapter with next separated tubes 40 lift in the port 86 areas. After testing, robot 174 takes MIC 44 and microplates 82 by wings 46 and move away from module 170.

This embodiment allows arranging analyzer 38 near centrifuge 24 and decreases the module 170 sizes. Said mini module 170 does not require waiting area in a working surface since sorting deck, centrifuge, compact analyzer and robot logically operate tubes arriving to the laboratory. This assembly intends to small laboratories and able to work in conjunction with sorting deck 20 and refrigerator storage 32 in a real time regime

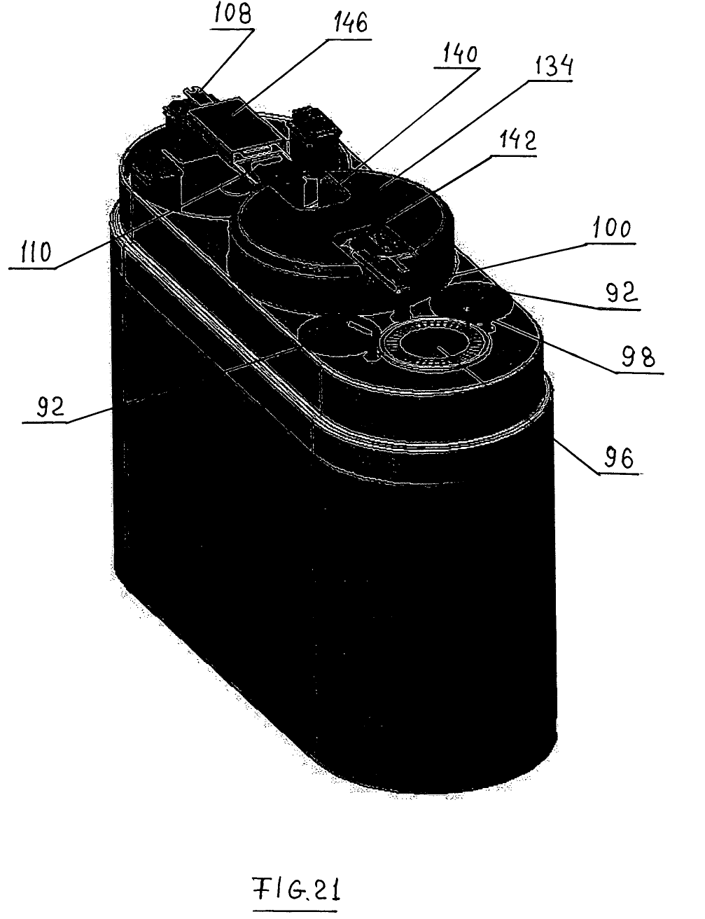

With reference to FIG. 20 and FIG. 21 shown the clinical analytical module 18 comprises coupling centrifuge 24, turn table 152, robot 34 and compact analyzer 26 having common working area and adjusted each other. Said module 18 uses direct centrifuge sampling method. Robot 34 connected module 18 with sorting deck 20.

Robotic assembly 34 built in conjunction with turntable 152. Turntable 152 contains the benches 144 for placing MIC 44 or universal adapter 66 and adjusting near centrifuge 24 loading area. Rotation mechanism 162 rotates turntable 152 about the rotation shaft coaxial with robotic revolving rod 130. The robotic manipulator 34 comprises base 128, connected with turntable 152 and revolving rod 130 coaxial with said base 128. Robotic arm 146 connected with the rod 130. Robotic arm 146 includes two grippers 108 and 110.

Robot 34 load tubes 40 inside MIC 44 or multi-item plates 72 and, after it, load said means with tubes inside centrifuge bucket 50. Gripper 108 embrace tubes 40 under caps 42 and transfer them to MIC. The robot gripper 110 configured like a fork and has a groove in an inner part to receive wings 46. Plate handling gripper 110 embraces the wings 46 by its inner surface. The wins lean in a surface of gripper groove. In alternative embodiments gripper lean in slots 78 of transporting means.

Centrifuge drum 132 and casing 134 in upper part configured with two apertures 136 and 138 so as to enable insertion of the robot gripper 110 and probe 100 within the centrifuge. Openings 136 and 138 closed by hatches or sash doors 140 and 142.

Centrifuge 24 in its inner part contains rotor 80 and buckets 50. Robot 34 takes MIC 44 or multi-item plates 72 with tubes 40 and place inside buckets 50, when centrifuge hatch 140 open. After centrifuging robot 34 moves away cap-covering 60 or multi-item plates 72 with caps 42 from centrifuge and tubes 40 are ready for direct centrifuge sampling.

Compact analyzer 26 includes two reaction tanks 92 with reaction containers, reagent tanks 96 with reagent containers, reagent pipettes 98 and washing device. Analyzer 26 may equip with at least one turn away specimen probe 100. Direct-centrifuge sampling method required automated rotor 80 indexing. When hatch 142 open, rotor 80 turns in determinate angle and adjust one bucket 50 near sample probes 100 position. LIS determinates specimen volume and tube arrangement in the said bucket 50. Probes 100 suck specimens from the tubes 40 placed inside bucket 50 in a logical manner and transfer it to analyzer processing rings 92. Using two specimen probes 100 decrease sampling time.

After sampling all tubes 40 in the first bucket 50, robot 34 removes MIC 44 or adapter 66 from bucket 50 and returns it to the turntable 38. At this time rotor 80 turn on 90 or 180 degree and other adapter 66 with next separated tubes adjust near sample probes 100 position. After testing, robot 34 takes MIC 44 or universal adapter 66 by wings and move away from module to recapping station arranged near the module. In the recapping station (not shown) robot 34 place multi caps 68 or 76 on the MIC 44 or adapter 66 and remove tubes 40 to the storage refrigerator 32.

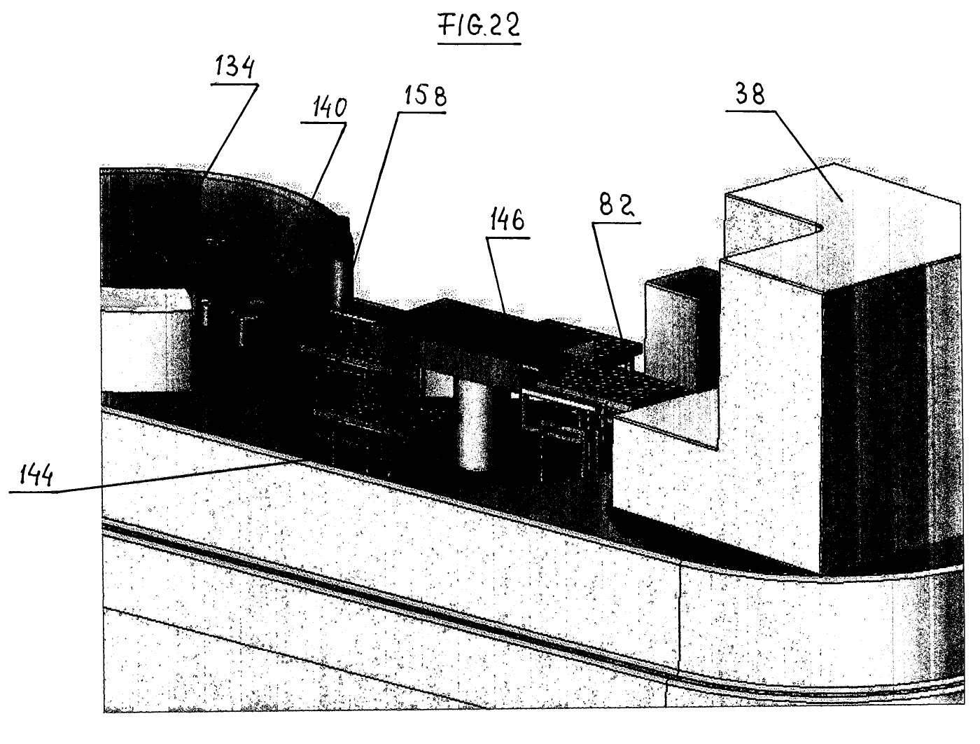

Said module does not require waiting area in a working surface since sorting deck, robot, rapid centrifuge and compact analyzer logically operate tubes arriving to the laboratory. With reference to FIG. 22 shown the biological analytical module 22 comprises coupling centrifuge 24, robotic unit 34, turntable 152, dispensing unit 36, biological analyzer 38 and/or plate hotel and chiller 150. Said module 22 uses direct centrifuge sampling method and provided with at least one swinging specimen probes 100. Using two specimen probes 100 decrease sampling time. Robot 34 connected module 22 with sorting deck 20. This module uses one robot 34 in the dispensing unit 36 and for loading—unloading tubes and microplates. Dispensing unit 36 arranges near centrifuge 24 sampling area. This embodiment decreases the module 22 sizes. Turntable 152 equipped with a bench 144 for placing MWC 44 and microplates 82. Rotation mechanism 162 rotates turntable 152 about the rotation shaft coaxial with robotic revolving rod 130.

The robotic manipulator 34 comprises base 128, connected with turntable 38 and revolving rod 130 coaxial with said base 128. Robotic arm 146 connected with the rod 130. Robot 34 load multi-item plates 72 with tubes 40 and microplates 82 provided with wings 46 or slots 78. Robotic arm 146 comprises gripper 110 and dispensing pipette 158. The gripper 110 configured like a fork and has a groove in an inner part to receive wings 46. Plate handling gripper 110 embraces the wings 46 by its inner surface. The wins lean in a surface of gripper groove. In alternative embodiments gripper lean in slots of transporting means.

Centrifuge drum 132 and casing 134 in upper part configured with at least one aperture 136 so as to enable insertion of the robot gripper 110 and probe 100 within the centrifuge inner area. Opening 136 closed by hatch or sash door 140. Centrifuge 24 in its inner part contains indexing rotor 80 with buckets 50. Robot 34 takes multi-item plates 72 with tubes 40 and place inside buckets 50, when centrifuge hatch 140 open. After centrifuging robot 34 move away multi-item plates 72 with caps 42 from centrifuge and tubes 40 are ready for direct centrifuge sampling. Rotor 80 turns in determinate angle and stop one bucket 50 near specimen probe 100 position. LIS determinates specimen volume and tube arrangement in the said bucket 50. Probe 100 suck samples from the tubes 40 placed inside bucket 50 in a logical manner and transfer it to microplate 82 placed on the bench 144 in a turntable 152.

In the dispensing unit 36 single or multi-item pipette 158 moves above microplate 82 and drop reagent inside microplate 82 wells. Robot 34 take said microplate 82 from the bench 144 and place inside plate hotel 150 or biological analyzer 38.

After sampling all tubes 40 in the first bucket 50, robot 34 places multi-cap 68 or 76 on tubes 40, removes said tubes 40 from bucket 50 and returns said multi-cap to the turntable 152. At this time rotor 80 turn on 90 or 180 degree and other adapter 66 with next separated tubes adjust near sample probes 100 position for specimen sampling into said or next microplate 82. After testing, robot 34 takes multi-cap 68 with tubes 40 and microplate 82 by wings and move away from module.

Said Module does not require waiting area in a working surface since sorting deck, dispensing unit, rapid centrifuge and compact analyzer logically operate tubes arriving to the laboratory.

1. An Universal Laboratory Automated System, comprising:
a General Level structure consist of:
a several High Level Laboratory Systems; and
a General Information System;
a High Level structure consist of:
a Main Laboratory; and
a Main Information System;
a Medium Level structure consist of:
a number of Clinical and Biologic Automated Analytical Stations; and
a Common Information System;
a Ground Level structure consist of:
a Hospitals;
a Blood Taking Stations;
a Physicians Offices; and
a Local Information System;
said Clinical Automated Analytical Station consist of:
a plurality of specimen tubes to store specimens;
a number of multi-item members for carrying a plurality of tubes and caps;
a sorting deck for selecting said tubes;
a rapid centrifuge equipped with swing-out rotor;
at least one analyzer for analysis of said samples;
at least one robotic assembly for tubes loading in rapid centrifuge and analyzer;
a bar code reading system;
a recapping station; and
a storage area;
said Biological Automated Analytical Station consist of:
a plurality of specimen tubes to store specimens;
a number of multi-item members for carrying a plurality of tubes and microplates;
a sorting deck for selecting said tubes;
a rapid centrifuge equipped with swing-out rotor;
a plurality of microplates to store the specimens;
a dispensing unit to dispense the specimens contained in the specimen tubes into the microplates;
at least one analyzer for analysis of said samples;
a robotic assembly for tubes and microplates loading in centrifuge and analyzer;
a bar code reading system;
a recapping station; and
a storage area.

2. The Automated Analytical System as defined in claim 1, wherein said Clinical Automated Analytical Station contains at least one Clinical Analytical Module; said Module consist of coupling sorting deck, centrifuge, robotic assembly, turn table and at least one analyzer.

3. The Automated Analytical System as defined in claim 2, wherein said Clinical Module comprises:
common casing for assembling several apparatus in one compact unit,
common processor for operating different parts of module,
common refrigerator,
robotic manipulator comprises a frame connected with a module, at least pair supporting rails, a bar movable along the supporting rails, robotic arm movable lengthways the bar; said arm provided with at least one simple plate handling gripper, movable regarding the robotic arm, said gripper configured like a fork and provided with a groove in an inner part to receive the wings of multi-item carriers and said arm provided with at least one tube handling gripper, movable regarding the robotic arm.

4. The Automated Analytical System as defined in claim 1, wherein said Biological Automated Analytical Station contains at least one biological pre-analytical module for microplate sampling; said module consist of coupling centrifuge, at least one multi-coordinate specimen probe, dispensing unit and at least one bidirectional carriage-shuttle for microplates placing, inner surface of the carriage fit an outside surface of the microplate to allow inserting said means into the carriage.

5. The Automated Analytical System as defined in claim 1, wherein said Biological Automated Analytical Station contains at least one Biological Analytical Modules; said Module consist of coupling sorting deck, robot, centrifuge, dispensing unit, plate hotel and chiller and at least one analyzer.

6. The Automated Analytical System as defined in claim 5, wherein said Biological Module comprises:
common casing fop assembling several apparatus in one compact unit,
common processor for operating different parts of module,
common refrigerator,
robotic unit comprises base and rod movable inside said base, robotic arm connected with the rod, said arm provided with at least one simple plate handling gripper said gripper has a fork shape and embrace wings or slots of multi-item carrier;
turntable provided with benches for placing multi-item carriers and microplates, said turntable rotation shaft coaxial with robotic revolving rod;
a rotation mechanism which rotates turntable about the rotation shaft,
a dispensing apparatus for placing reagents inside multi-well plates, and
common motors.

7. The Automated Analytical System as defined in claim 2, wherein said module provided with tube handler; said handler displace between centrifuge and analyzer and contains:
a multi-coordinate specimen probe for taking specimens from tubes loaded inside multi-item carriers and placing said specimens to analyzer processing ring;
a conveyor means including plural substantially identical receptacles, for receiving multi-item carriers from centrifuge and conveying said sample carriers with tubes to said specimen probe.

8. The Automated Analytical System as defined in claim 2, in which said centrifuge comprising:
a rotor with a holding means being pivotable about a pivoting axis with respect to the rotor, a common center of gravity of the holding means and the tubes within, being variable during the separation process;
a displacing means for displacing the common center of gravity of the holding means with the tube carried thereby from a first location to a second location situated below the first location, said displacing means is tube adapter;
a stopping means for maintaining a selected degree of inclination of the tube when it is pivoted in said first position; and
at least one aperture in side walls of centrifuge casing and drum, for tubes loading and direct centrifuge sampling, said apertures closed by hatches and/or sash doors.

9. The Automated Analytical System as defined in claim 8, in which said centrifuge provided with cap removing means, formed integrally with the displacing means, said cap removing means comprising:
a detachable plate connected to an upper part of the holding means, said plate contains plurality of compartments for cap holding after removing from tubes, said plate being provided with a perforated partition transverse to the length of the tube, the diameter of at least one perforation of the partition fitting the outside diameter of the tube so as to allow insertion of the tube within the holding means through the perforation, and the cap having an outside diameter larger than the perforation diameter;
an adapter for supporting the tube after being inserted in the holding means, said adapter movable by the centrifugal force along the longitudinal axis of the holding means from an uppermost position to a lowermost position;
an electromechanical fixing means for preventing movement of the adapter and the tube by the centrifugal force from the uppermost position toward the lowermost position when the holding means is pivoted in the incline position, said an electro-mechanical fixing means comprise electro-sensor, timer and a self-aligning control system;
a spring means for returning the adapter and the tube from the lowermost position into the uppermost position;
whereby the tube is movable within the adapter by the centrifugal force toward the lowermost position until the cap leans against the partition so as to remove the cap from the tube.

10. The Automated Analytical System as defined in claim 2, in which said analyzer comprising:
a specimen carousel for multi-item carriers placing; said carousel comprises a number of identical receptacles for receiving and rotating multi-item carriers, inner surface of the receptacle fit an outside surface of the multi-item carrier and universal adapter to allow inserting said means into the analyzer.
a swinging specimen probe for taking specimen from the tubes loaded on said carousel, inside multi-item carriers.

11. The Automated Analytical System as defined in claim 2, in which said Analyzer comprising:
a multi-coordinate specimen probe for taking specimen from the tubes loaded inside multi-item carriers;
a multi-coordinate carriage—bidirectional shuttle, for multi-item carrier placing, said carriage include at least one receptacle for receiving multi-item carrier and attaching said carrier near specimen probe, inner surface of the receptacle fit an outside surface of the multi-item carrier and universal adapter to allow inserting said means into or near the analyzer.

12. The Automated Analytical System as defined in claim 1, in which said multi-item means is a tube carrier, formed integrally with cap removing plate, said means comprising:
a perforated partition transverse to the length of the tube, the diameter of at least one perforation of the partition fitting the outside diameter of the tube so as to allow insertion of the tube within the holding means through the perforation;
plurality deflectable clamps, said clamps embrace tubes and hold them during loading-unloading operations;
at least a pair protrusions—wings and/or slots on side walls, permitting to arrange the carrier on a robot simply plate gripper;
at least pair extending up deflectable, springy catches, permitting to lock cap covering with caps on a centrifuge holding means during spin.

13. The Automated Analytical System as defined in claim 1, in which said multi-item member is a tube carrier, formed integrally with centrifuge universal adapter, said means comprising:
at least one compartment for tube holding, the diameter of compartment fit the outside diameter of the tube so as to allow insertion the tube within the adapter;
at least a pair protrusions—wings and/or slots on side walls, permitting to arrange the carrier on a robot simply plate gripper;
at least pair extending up deflectable, springy catches, permitting to lock cap covering with caps on a centrifuge holding means during spin.

14. The Automated Analytical System as defined in claim 1, in which said multi-item member is a microplate, provided with plurality wells for specimen sampling, said means comprising:
at least a pair protrusions—wings and/or slots on side walls, permitting to arrange the carrier on a robot simply plate gripper.

15. The Automated Analytical System as defined in claim 1, in which said multi-item member is a microplate carrier, formed integrally with centrifuge adapter, said means comprising:
a hollow body, inner surface of the adapter fit an outside surface of the microplate to allow inserting at least one microplate into the adapter;
at least two openings on a sidewall to provide microplates wings to protrude from said walls, permitting loading said microplates inside adapter by robotic simply plate handling gripper;
at least a pair protrusions—wings and/or slots on side walls, permitting to arrange the carrier on a robotic simply plate handling gripper.

16. The Automated Analytical System as defined in claim 1, in which said multi-item member is a multi-cap carrier, formed integrally with cap removing plate, said means comprising:
a perforated partition transverse to the length of the tube, the diameter of at least one perforation of the partition fitting the outside diameter of the tube so as to allow insertion of the tube within the holding means through the perforation;
plurality of compartments for cap holding after removing from tubes; said compartments provided with a springy walls, permitting to lock caps on a centrifuge holding means during spin;
at least a pair protrusions—wings and/or slots on side walls, permitting to arrange the carrier on a robot simply plate gripper.

17. The Automated Analytical System as defined in claim 1, in which said multi-item member is a multi-cap covering formed integrally with cap removing means, said means comprising:
plurality of compartments for cap holding after removing from tubes, said compartments provided with a springy walls, permitting to lock caps inside cap covering during removing from centrifuge holding means;
at least two openings on a sidewall to connect with catches of multi-item carrier;
at least a pair protrusions—wings and/or slots on side walls, permitting to arrange the carrier on a robot simply plate gripper.

18. The Automated Analytical System as defined in claim 1, in which said multi-item member is a multi-cap, said means comprising:
plurality of united caps for tube sealing after sampling, said means being provided with a springy walls, permitting to lock tubes inside multi-cap during removing from centrifuge holding means;
at least a pair protrusions—wings and/or slots on side walls, permitting to arrange the carrier on a robot simply plate gripper.

19. The Automated Analytical System as defined in claim 1, in which said multi-item members are disposable means.

20. A method for routing a specimen through Clinical Automated Analytical Station, comprising the steps:
providing a plurality of specimens to be tested in a plurality of specimen tubes;
inputting information regarding the specimens and tests to be conducted on the specimens into a computerized laboratory information system;
at sorting station, making specimens measuring and batch size calculation;
making specimens sorting to different tests, compiling batch size and placing batch identification information into laboratory information system;
placing tubes with specimens into multi-item carriers using batch information and entering the carriers into the module receiving deck;
at the module, placing a set of said carriers into centrifugation assembly by using robotic assembly, for specimens separation and/or cap removing;
removing carriers with tubes from centrifuge by using robotic assembly and directing said carriers to the first analyzer;
placing at least one carriers with tubes on analyzer specimen indexing multi-item carousel;
sampling specimens from the tubes loaded within multi-item carriers by using multi-coordinate swinging specimen probe;
conducting the first predetermined test on the first set of specimens;
directing the first set of carriers to the next analyzer or module by using robotic assembly, upon completion of the test;
removing multi-item carriers from analyzer to the storage area by using robotic assembly;
inputting the results of tests conducted on said specimens into the Laboratory Information System.

21. The method as defined in claim 20, in which the step of specimen separation is effected when the tube rotates about the rotor and is pivoted in a first position, in which walls of the tube are inclined with respect to the vector of the centrifugal force, said inclination angle is about (70-90) degree in a case of a whole blood and is about (0-30) degree in a case of a clot blood.

22. The method as defined in claim 20, in which the step of removing caps from tubes residing within a tube holder is effected in a centrifugation process by electromechanical fixing means, said method comprising the steps:
providing at least one tube with a blood sample and a cap within universal adapter,
placing said adapter within a centrifugation assembly having a rotor and a bucket for carrying the adapter,
rotating the rotor about a rotor axis to produce a centrifugal force having its vector radiating from the rotor axis,
sending a signal to a self—aligning control system of the fixing means,
removing the fixing means from the protruding position to relieve the adapter,
displacing the adapter along the bucket by the centrifugal force, toward a lowermost adapter position,
engaging the cap against a detachable cap removing plate on the holder,
shifting tube along the adapter by the centrifugal force, toward a lowermost position, so as to remove the cap from the tube,
returning the adapter and the tube from the lowermost position into an uppermost position, after stopping the rotor, and
removing said cap removing plate with caps from centrifuge.

23. The method as defined in claim 20, in which the steps of specimen sampling is effected from the tubes loaded within multi-item carrier, said carrier placed inside movable bidirectional carriage arranged on analyzer, said analyzer provided with standard specimen probe.

24. The method as defined in claim 20, in which the steps of specimen sampling is effected from the tubes loaded within multi-item carrier, said carrier placed inside tube handler, said handler placed near centrifuge and analyzer and provided with at least one indexing swinging sample probe.

25. The method as defined in claim 20, in which the steps of specimen sampling is effected from the tubes loaded within multi-item carrier, said carrier placed inside centrifuge bucket, said centrifuge provided with indexing rotor and at least one indexing swinging sample probe.

26. A method for routing a specimen through Biological Automated Analytical Station, comprising the steps:
providing a plurality of specimens to be tested in a plurality of specimen tubes;
inputting information regarding the specimens and tests to be conducted on the specimens into a computerized laboratory information system;
at sorting station, making specimens measuring and batch size calculation;
making specimens sorting and placing batch identification information into laboratory information system;
loading tubes with specimens inside multi-item carriers and entering the carriers into the module receiving deck;
at the module, placing a set of said carriers into centrifugation assembly by using robotic assembly, for specimens separation and/or cap removing;
placing empty microplates on movable bidirectional carriage arranged near centrifuge for microplates sampling and reagent adding;
sampling specimens from the tubes loaded within centrifuge to microplate wells by using swinging multi-coordinate sampling probe;
adding reagents to microplates in dispensing unit;
placing said microplates inside plate hotel;
placing said microplates in analyzer sampling inlet;
conducting the test on the first set of specimens;
removing multi-item carriers from centrifuge and microplates from analyzer by using robotic assembly; and
inputting the results of tests conducted on said specimens into the Laboratory Information System.

27. The method as defined in claim 26, in which the steps of microplates sampling is effected by steps:
providing at least one multi-item carrier with tubes inside centrifuge bucket; said tubes accessible to specimen probe;
placing empty microplates on stationary carriage arranged near centrifuge;
sampling specimens from the tubes loaded within centrifuge to microplate wells by using swinging multi-coordinate sampling probe.
